(19) United States
(12) Patent Application Publication
(10) Pub. No.: US 2019/0072215 A1
(43) Pub. Date: Mar. 7, 2019

(54) ROTARY SHOULDER CONNECTIONS FOR THREADED PIPE CONNECTIONS

(71) Applicant: Black Diamond Oilfield Rentals LLC, Houston, TX (US)

(72) Inventors: Jim Douglas, Pearland, TX (US); Charles G. Kibbe, New Iberia, LA (US); Jerrod B. Olivier, New Iberia, LA (US); Christopher M. Biggerstaff, Houston, TX (US)

(73) Assignee: Black Diamond Oilfield Rentals LLC, Houston, TX (US)

(21) Appl. No.: 15/924,709

(22) Filed: Mar. 19, 2018

Related U.S. Application Data
(60) Provisional application No. 62/554,347, filed on Sep. 5, 2017.

(51) Int. Cl. F16L 15/00; E21B 17/042

(52) U.S. Cl. CPC F16L 15/001; E21B 17/042

(57) ABSTRACT

A rotary shoulder connection comprising: a box connection, wherein the box connection has a box outer radius, a box counter bore radius and a box inner radius, and box threads having a box thread form cut along a box taper; a pin connection, wherein the pin connection has a pin outer radius, a pin cylinder radius and a pin nose radius, and pin threads having a pin thread form cut along a pin taper to align with the box threads inside the box connection; and a primary shoulder connection comprising: a primary box shoulder at a primary box angle from greater than about 0 to about 15 degrees with respect to a first perpendicular to a box axis at a first end point; a primary pin shoulder at a primary pin angle from about 0 to about 15 degrees with respect to the first perpendicular to a pin axis at the first end point is disclosed. Methods of using the rotary shoulder connection are also disclosed.

### PRIOR RELATED APPLICATIONS

This application claims benefit of U.S. Provisional Patent Application Ser. No. 62/554,347 entitled “IMPROVED ROTARY SHOULDER CONNECTIONS FOR THREADED PIPE CONNECTIONS,” filed on Sep. 5, 2017.

### FEDERALLY SPONSORED RESEARCH STATEMENT

Not Applicable (N/A)

### REFERENCE TO MICROFICHE APPENDIX

N/A

### FIELD OF INVENTION

The present invention relates generally to a rotary shoulder connection and methods thereof and, more particularly, to an improved rotary shoulder connection with primary and secondary angled shoulder features for threaded pipe connections in various drill strings and methods thereof.

### BACKGROUND OF THE INVENTION

Standard (typical) double-shoulder connections and standard (typical) single-shoulder connections suffer from the problem of box “swell” (e.g., box material yields) due to tapered threads, included thread profile angle and high generated axial compressive loads. The box swell forces force the primary shoulder of the box connection outward, causing deformation of and/or permanent damage to the box connection.

Standard (typical) double-shoulder connections and standard (typical) single-shoulder connections also suffer from the problem of pin collapse. The pin collapse forces push a portion of the pin nose inward, causing deformation of and/or permanent damage to the pin connection.

This combination of box swell (e.g., box material yields) and pin collapse can lead to misalignment of the box threads and the pin threads, as well as permanent damage to the box connection and/or the pin connection. Over time, the box threads become misaligned with the pin threads, causing damage to the box threads and/or the pin threads.

Further, this combination of box swell (e.g., box material yields) and pin collapse, in conjunction with high alternating axial, torsional, and bending loads, can lead to premature fatigue failure of the standard (typical) double-shoulder connection and standard (typical) single-shoulder connection, damage to the box threads and/or the pin threads, and permanent deformation of the box connection and/or the pin connection to reduce the effects of box swell (e.g., box material yields) and pin collapse.

Thus, an improved double-shoulder connection and an improved single-shoulder connection are needed to eliminate these problems.

### SUMMARY OF THE INVENTION

In an embodiment, a rotary shoulder connection comprises an angled primary shoulder and/or an angled secondary shoulder.

In an embodiment, the rotary shoulder connection comprises: a box connection having a box axis, a pin connection having a pin axis and a primary shoulder connection at a first end of the box connection and a first end of the pin connection.

In an embodiment, the box connection has a box outer radius, a box counter bore radius and a box inner radius, and box threads having a box thread form cut along a box taper.

In an embodiment, the pin connection has a pin outer radius, a pin cylinder radius and a pin nose radius, and pin threads having a pin thread form cut along a pin taper to align with the box threads inside the box connection.

In an embodiment, the primary shoulder connection comprises: a primary box shoulder at a primary box angle with respect to a first perpendicular to the box axis at a first end point of the box connection; and a primary pin shoulder at a primary pin angle with respect to the first perpendicular to the pin axis at the first end point of the pin connection. In an embodiment, the first end point is equal to a datum intersection.

In an embodiment, the primary box angle is about 0 degrees and the primary pin angle is about 0 degrees.

In an embodiment, the primary box angle is from greater than or equal to about 0 degrees to less than or equal to about 15 degrees. In an embodiment, the primary box angle is from greater than or equal to about 0 degrees to less than or equal to about 10 degrees. In an embodiment, the primary box angle is about 5 degrees. In an embodiment, the primary box angle is about 0 degrees.

In an embodiment, the primary pin angle is from greater than or equal to about 0 degrees to less than or equal to about 15 degrees. In an embodiment, the primary pin angle is from greater than or equal to about 0 degrees to less than or equal to about 10 degrees. In an embodiment, the primary pin angle is about 5 degrees. In an embodiment, the primary pin angle is about 0 degrees.

In an embodiment, the primary box angle is about equal to the primary pin angle to form a first seal.

In an embodiment, the primary box angle is slightly different than the primary pin angle to form a first seal. In an embodiment, the first seal is a gas-tight seal.

In an embodiment, the primary box shoulder contacts the primary pin shoulder to form a first seal. In an embodiment, the primary box shoulder is conical shaped (outside of cone, male) and the primary pin shoulder is conical shaped (inside of cone, female).

In an embodiment, the box thread form comprises a first box thread crest, a second box thread crest, a first box thread flank, a second box thread flank, a box included angle between the first box thread flank and the second box thread flank, and a box thread root. In an embodiment, the box thread form is selected from the group consisting of square, triangular, trapezoidal, and variations thereof. In an embodiment, the first box thread crest and/or the second box thread crest is circular, square, triangular or trapezoidal shaped. In an embodiment, the first box thread flank and/or the second box thread flank are concave, convex, or straight shaped. In an embodiment, the box thread root is circular, square, triangular or trapezoidal shaped. In an embodiment, the box included angle is from about 29 degrees to about 90 degrees. In an embodiment, the box thread form is triangular and the box included angle is about 60 degrees.

In an embodiment, the pin thread form comprises a first pin thread crest, a second pin thread crest, a first pin thread flank, a second pin thread flank, a pin included angle between the first pin thread flank and the second pin thread flank, and a pin thread root. In an embodiment, the pin thread form is selected from the group consisting of square, triangular, trapezoidal, and variations thereof. In an embodiment, the first pin thread crest and/or the second pin thread crest is circular, square, triangular or trapezoidal shaped. In an embodiment, the first pin thread flank and/or the second pin thread flank are concave, convex, or straight shaped. In an embodiment, the pin thread root is circular, square, triangular or trapezoidal shaped. In an embodiment, the pin included angle is from about 29 degrees to about 90 degrees. In an embodiment, the pin thread form is triangular shaped and the pin included angle is about 60 degrees.

In an embodiment, the box threads and/or the pin threads are treated by one or more of cold rolling, shot peening, phosphating, fluoropolymer coating, ceramic coating, chrome plating, anodizing, and variations thereof. In an embodiment, the box threads and/or the pin threads are treated by one or more of cold rolling, shot peening, fluoropolymer coating, and anodizing.

In an embodiment, the rotary shoulder connection further comprises one or more of a box boreback, a box stress relief groove and a pin stress relief groove.

In an embodiment, the rotary shoulder connection is made from one or more of low alloy steels, stainless steels, super alloys, titanium alloys, copper alloys, cobalt alloys, aluminum alloys, and variations thereof. In an embodiment, the rotary shoulder connection is made from one or more of low alloy steels, stainless steels, and variations thereof.

In an embodiment, the rotary shoulder connection is applied to one or more of drill pipe, heavy weight drill pipe, drill collars, pup joints, crossover subs, saver subs, bit subs, float subs, pump-in subs, inside blowout preventers, top drive shafts, top drive valves, safety valves, kelly valves, hoisting equipment, swivels, fishing tools, mud motors, rotary steerable tools, drill bits, directional drilling bottom hole assembly components, measurement while drilling components, logging while drilling components, well cleanout tools, completion tools, and variations thereof. In an embodiment, the rotary shoulder connection is applied to one or more of drill pipe, heavy weight drill pipe, drill collars, pup joints, and variations thereof.

In an embodiment, the rotary shoulder connection further comprises: a secondary shoulder connection at a second end of the box connection and a second end of the pin connection. In an embodiment, the secondary shoulder connection comprises: a secondary box shoulder at a secondary box angle with respect to a second perpendicular to the box axis at the second end point of the box connection; and a secondary pin shoulder at a secondary pin angle with respect to the second perpendicular to the pin axis at the second end point of the pin connection.

In an embodiment, the second end is offset a second distance from the first end. In an embodiment, the second distance is from about 2 inches to about 8 inches. In an embodiment, the second distance is a connection length.

In an embodiment, the secondary box angle is about 0 degrees and the secondary pin angle is about 0 degrees.

In an embodiment, the secondary box angle is from greater than or equal to about 0 degrees to less than or equal to about 15 degrees. In an embodiment, the secondary box angle is from greater than or equal to about 0 degrees to less than or equal to about 10 degrees. In an embodiment, the secondary box angle is about 5 degrees. In an embodiment, the secondary box angle is about 0 degrees.

In an embodiment, the secondary pin angle is from greater than or equal to about 0 degrees to less than or equal to about 15 degrees. In an embodiment, the secondary pin angle is from greater than or equal to about 0 degrees to less than or equal to about 10 degrees. In an embodiment, the secondary pin angle is about 5 degrees. In an embodiment, the secondary pin angle is about 0 degrees.

In an embodiment, the secondary box angle is about equal to the secondary pin angle to form a torque shoulder.

In an embodiment, the secondary box angle is slightly different than the secondary pin angle to form a torque shoulder that is a second seal. In an embodiment, the torque shoulder or the second seal is a gas-tight seal.

In an embodiment, the secondary box shoulder contacts the secondary pin shoulder to form a torque shoulder. In an embodiment, the secondary box shoulder is conical shaped (outside of cone, male) and the secondary pin shoulder is conical shaped (inside of cone, female).

In an embodiment, the box thread form comprises a first box thread crest, a second box thread crest, a first box thread flank, a second box thread flank, a box included angle between the first box thread flank and the second box thread flank, and a box thread root. In an embodiment, the box thread form is selected from the group consisting of square, triangular, trapezoidal, and variations thereof. In an embodiment, the first box thread crest and/or the second box thread crest is circular, square, triangular or trapezoidal shaped. In an embodiment, the first box thread flank and/or the second box thread flank are concave, convex, or straight shaped. In an embodiment, the box thread root is circular, square, triangular or trapezoidal shaped. In an embodiment, the box included angle is from about 29 degrees to about 90 degrees. In an embodiment, the box thread form is triangular and the box included angle is about 60 degrees.

In an embodiment, the pin thread form comprises a first pin thread crest, a second pin thread crest, a first pin thread flank, a second pin thread flank, a pin included angle between the first pin thread flank and the second pin thread flank, and a pin thread root. In an embodiment, the pin thread form is selected from the group consisting of square, triangular, trapezoidal, and variations thereof. In an embodiment, the first pin thread crest and/or the second pin thread crest is circular, square, triangular or trapezoidal shaped. In an embodiment, the first pin thread flank and/or the second pin thread flank are concave, convex, or straight shaped. In an embodiment, the pin thread root is circular, square, triangular or trapezoidal shaped. In an embodiment, the pin included angle is from about 29 degrees to about 90 degrees. In an embodiment, the pin thread form is triangular shaped and the pin included angle is about 60 degrees.

In an embodiment, the box threads and/or the pin threads are treated by one or more of cold rolling, shot peening, phosphating, fluoropolymer coating, ceramic coating, chrome plating, anodizing, and variations thereof. In an embodiment, the box threads and/or the pin threads are treated by one or more of cold rolling, shot peening, fluoropolymer coating, and anodizing.

In an embodiment, the rotary shoulder connection further comprises one or more of a box boreback, a box stress relief groove and a pin stress relief groove.

In an embodiment, the rotary shoulder connection is made from one or more of low alloy steels, stainless steels, super alloys, titanium alloys, copper alloys, cobalt alloys, aluminum alloys, and variations thereof. In an embodiment, the rotary shoulder connection is made from one or more of low alloy steels, stainless steels, and variations thereof.

In an embodiment, the rotary shoulder connection is applied to one or more of drill pipe, heavy weight drill pipe, drill collars, pup joints, crossover subs, saver subs, bit subs, float subs, pump-in subs, inside blowout preventers, top drive shafts, top drive valves, safety valves, kelly valves, hoisting equipment, swivels, fishing tools, mud motors, rotary steerable tools, drill bits, directional drilling bottom hole assembly components, measurement while drilling components, logging while drilling components, well cleanout tools, completion tools, and variations thereof. In an embodiment, the rotary shoulder connection is applied to one or more of drill pipe, heavy weight drill pipe, drill collars, pup joints, and variations thereof.

In an embodiment, a method of using a rotary shoulder connection comprises: providing a rotary shoulder connection; and applying the rotary shoulder connection to one or more products. In an embodiment, the rotary shoulder connection may be the improved double-shoulder connection with an angled primary shoulder or the improved single-shoulder connection with an angled primary shoulder, as discussed above.

In an embodiment, the method further comprises tightening the rotary shoulder connection between one of more products to form the first seal.

In an embodiment, the method further comprises tightening the rotary shoulder connection between the one or more products to form the first seal and the torque shoulder.

In an embodiment, a method for determining a primary shoulder location comprises: locating a pitch line parallel to a connection box/pin taper; locating a first intersection of a pitch diameter and the pitch line; locating a first perpendicular to the connection box/pin axis at the first intersection; locating a second perpendicular to the connection box/pin axis at a first distance towards a primary box/pin shoulder from the first perpendicular; and locating a second intersection of the pitch line and the second perpendicular.

In an embodiment, the method for determining a primary shoulder location further comprises defining a primary box/pin angle with respect to the second perpendicular at the second intersection.

In an embodiment, the first distance is from about 0.5 inch to about 2.50 inches. In an embodiment, the first distance is from about 0.625 inch to about 2.250 inches. In an embodiment, the first distance is about 0.625 inch.

In an embodiment, a method for determining a secondary shoulder connection location comprises: locating a pitch line parallel to a connection box/pin taper; locating a first intersection of a pitch diameter and the pitch line; locating a first perpendicular to the connection box/pin axis at the first intersection; locating a second perpendicular to the connection box/pin axis at a first distance towards a primary box/pin shoulder from the first perpendicular; locating a second intersection of the pitch line and the second perpendicular; locating a third perpendicular to the connection box/pin axis at a second distance toward a secondary box/pin shoulder; and locating a third intersection of a pin nose outer diameter and the third perpendicular.

In an embodiment, the second distance may be about 2 inches to about 8 inches. In an embodiment, the second distance is a connection length.

In an embodiment, the method for determining a secondary shoulder location further comprises optionally, defining a primary box/pin angle with respect to the second perpendicular at the second intersection and defining a secondary box/pin angle with respect to the third perpendicular at the third intersection.

In an embodiment, the method for determining a secondary shoulder location comprises defining a secondary box/pin angle with respect to the third perpendicular at the third intersection.

These and other objects, features and advantages will become apparent as reference is made to the following detailed description, preferred embodiments, and examples, given for the purpose of disclosure, and taken in conjunction with the accompanying drawings and appended claims.

### BRIEF DESCRIPTION OF THE DRAWINGS

For a further understanding of the nature and objects of the present invention, reference should be made to the following detailed disclosure, taken in conjunction with the accompanying drawings, in which like parts are given like reference numerals, and wherein:

FIG. 1A illustrates a partial cross-sectional view of a double-shoulder connection with a pin and box made-up (screwed together), showing box connection features;

FIG. 1B illustrates the double-shoulder connection of FIG. 1A, showing pin connection features;

FIG. 2A illustrates a cross-sectional view of a standard (typical) double-shoulder connection, showing a standard primary shoulder connection and a standard secondary shoulder connection;

FIG. 2B illustrates a detailed view C1 in FIG. 2A, showing the standard primary shoulder connection;

FIG. 2C illustrates a detailed view C2 in FIG. 2A, showing the standard secondary shoulder connection;

FIG. 3A illustrates a cross-sectional view of the standard (typical) double shoulder connection shown in FIG. 2A, showing an exaggerated deformation of the box connection and the pin connection for clarity purposes;

FIG. 3B illustrates a detailed view D in FIG. 3A, showing a thread misalignment;

FIG. 4A illustrates a cross-sectional view of an improved double-shoulder connection with an angled primary shoulder and a standard secondary shoulder according to an embodiment of the present invention;

FIG. 4B illustrates a detailed view E in FIG. 4A, showing the angled primary shoulder according to an embodiment of the present invention;

FIG. 5A illustrates a cross-sectional view of the improved double-shoulder connection of FIG. 4A, showing box radial retaining forces and pin radial retaining forces;

FIG. 5B illustrates a detailed view F in FIG. 5A, showing improved thread alignment;

FIG. 6A illustrates a cross-sectional view of an improved double-shoulder connection with a standard primary shoulder and an angled secondary shoulder according to an embodiment of the present invention, showing box radial retaining forces and pin radial retaining forces;

FIG. 6B illustrates a detailed view G in FIG. 6A, showing the angled secondary shoulder according to an embodiment of the present invention;

FIG. 7 illustrates a cross-sectional view of an improved double-shoulder connection with an angled primary shoulder and an angled secondary shoulder according to an embodiment of the present invention;

FIG. 8A illustrates a cross-sectional view of an improved single-shoulder connection with an angled primary shoulder according to an embodiment of the present invention;

FIG. 8B illustrates a detailed view H in FIG. 8A, showing the angled primary shoulder according to an embodiment of the present invention;

FIG. 9 illustrates a cross-sectional view of an improved single-shoulder connection with box and pin stress relief grooves according to an embodiment of the present invention;

FIG. 10 illustrates a cross-sectional view of an improved single-shoulder connection with a box boreback and a pin stress relief groove according to an embodiment of the present invention;

FIG. 11 illustrates a cross-sectional detailed view of a thread form according to an embodiment of the present invention;

FIG. 12 illustrates a cross-sectional view of an improved primary connection shoulder according to an embodiment of the present invention;

FIG. 13 illustrates a flow chart of a method for determining a primary connection shoulder location according to an embodiment of the present invention;

FIG. 14 illustrates a cross-sectional view of an improved secondary connection shoulder according to an embodiment of the present invention;

FIG. 15 illustrates a flowchart of a method for determining a secondary connection shoulder location according to an embodiment of the present invention; and

FIG. 16 illustrates a flowchart of a method of using an improved double-shoulder connection with an angled primary shoulder or an improved single-shoulder connection with an angled primary shoulder according to an embodiment of the present invention.

### DETAILED DESCRIPTION OF EMBODIMENTS OF THE INVENTION

The following detailed description of various embodiments of the present invention references the accompanying drawings, which illustrate specific embodiments in which the invention can be practiced. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains. Therefore, the scope of the present invention is defined only by the appended claims, along with the full scope of equivalents to which such claims are entitled.

Double-Shoulder Connection with Box and Pin Made-Up

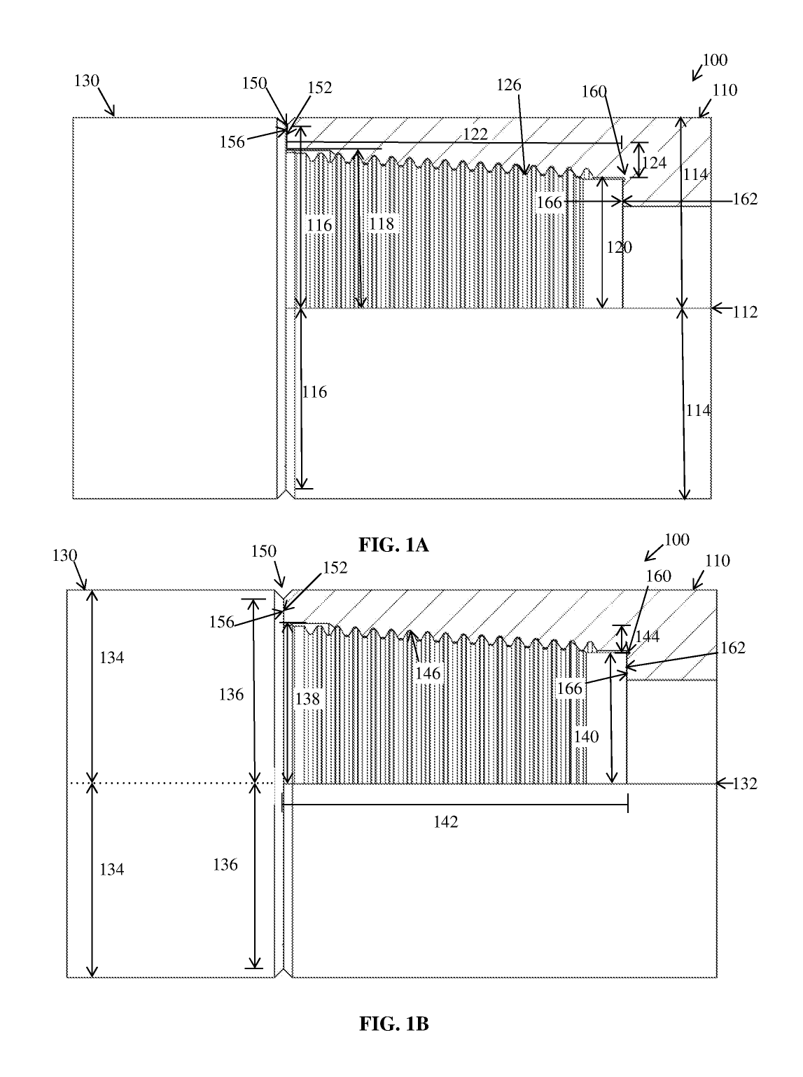

FIG. 1A illustrates a partial cross-sectional view of a double-shoulder connection 100 with a pin and box made-up (screwed together), showing box connection 110 features; and FIG. 1B illustrates the double-shoulder connection 100 of FIG. 1A, showing pin connection 130 features. As shown in FIGS. 1A & 1B, the double-shoulder connection 100 comprises a box connection 110 having a box axis (centerline) 112, a pin connection 130 having a pin axis (centerline) 132, a primary shoulder 150 and a secondary shoulder 160.

In an embodiment, the box connection 110 comprises a box axis (centerline) 112, a box outer radius 114, a box bevel radius 116, a box counter bore radius 118, a box inner radius 120, a box depth 122, a box taper 124 and box threads 126 cut along the box taper 124. The box connection 110 is a female, internally threaded half of the double-shoulder connection 100, similar to a nut. See FIGS. 1A & 1B.

In an embodiment, the pin connection 130 comprises a pin axis (centerline) 132, a pin outer radius 134, a pin bevel radius 136, a pin cylinder radius 138, a pin nose radius 140, a pin length 142, a pin taper 144 and pin threads 146 cut along the pin taper 144. The pin connection 130 is a male, externally threaded half of the double-shoulder connection 100, similar to a bolt. See FIGS. 1A & 1B.

In an embodiment, any suitable connection box/pin taper 124, 144 may be used for the box/pin connection 100. For example, suitable connection box/pin taper 124, 144 may be from about ¾ inch per foot to about 3 inches per foot, and any range or value there between.

In an embodiment, any suitable thread pitch may be used for the box threads 426, 526, 626, 726, 826, 926, 1026, 1226, 1446 and/or pin threads 446, 546, 646, 746, 846, 946, 1046, 1246, 1446. For example, suitable thread pitches may be from about 3 threads per inch to about 5 threads per inch, and any range or value there between.

In an embodiment, any suitable thread form 1100 may be used for the box threads 426, 526, 626, 726, 826, 926, 1026, 1226, 1426 and/or pin threads 446, 546, 646, 746, 846, 946, 1046, 1246, 1446. Suitable thread forms 1100 may have various crest 1110, 1112, flank 1130, 1140 and root 1160 shapes with an included angle 1150 from about 29 degrees to about 90 degrees, and any range or value there between, as discussed below.

### Standard (Typical) Double Shoulder Connections

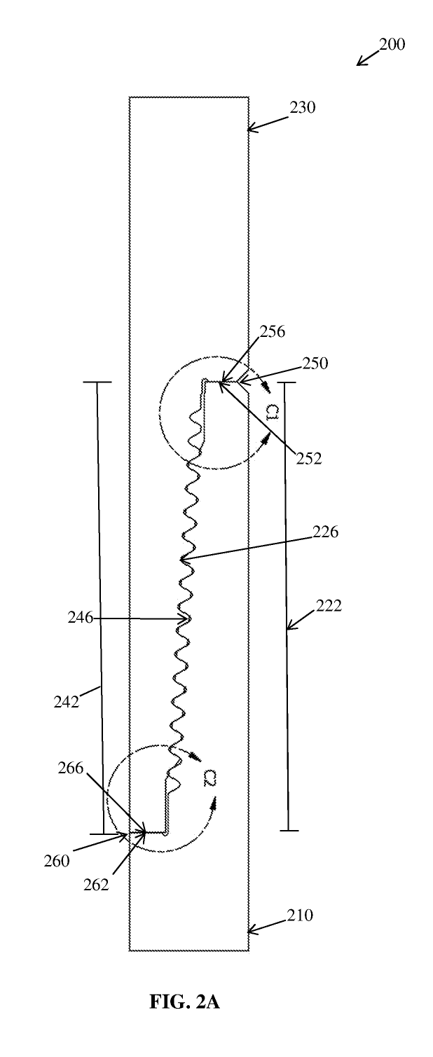

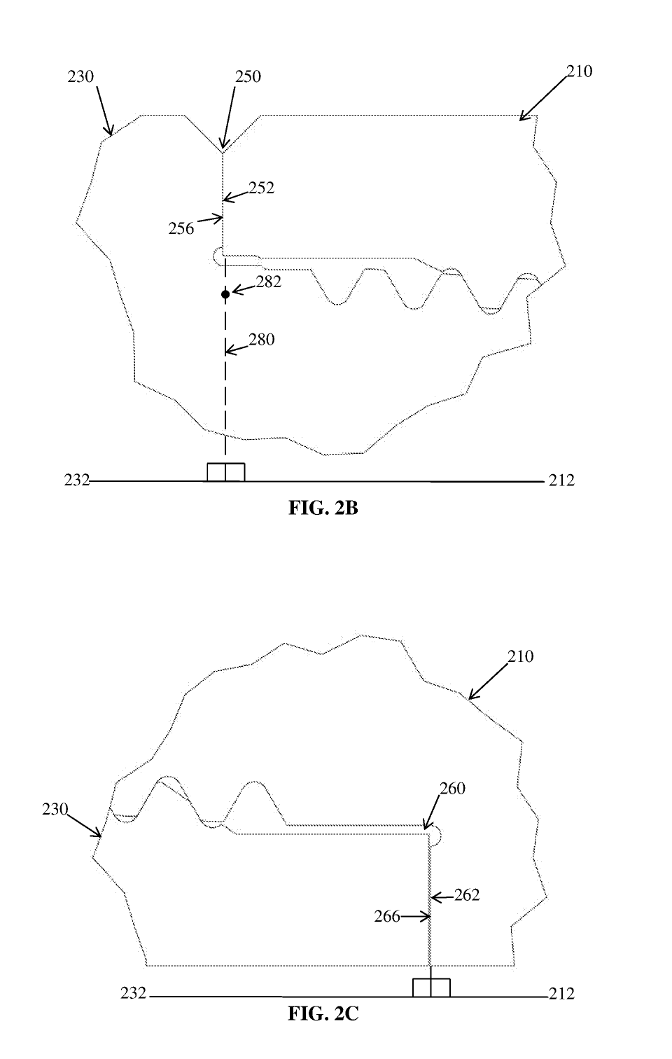

FIG. 2A illustrates a cross-sectional view of a standard (typical) double-shoulder 200 connection, showing a standard primary shoulder connection 250 and a standard secondary shoulder connection 260. As shown in FIG. 2A, the standard (typical) double-shoulder connection 200 comprises a box connection 210 having a box axis 112, a pin connection 230 having a pin axis 132, a primary shoulder 250 and a secondary shoulder 260.

The primary shoulder 250 comprises a primary box shoulder 252 at a primary box angle with respect to a first perpendicular 280 to the box axis 112 at a first end point 282 of the box connection; and a primary pin shoulder 256 at a primary pin angle with respect to the first perpendicular 280 to the pin axis 132 at the first end point 282 of the pin connection. See also FIG. 1A: 112 & FIG. 1B: 132 (showing box and pin made-up).

In a standard double-shoulder connection, the primary box angle is 0 degrees (i.e., primary box shoulder 252 is perpendicular to the box axis 112) and the primary pin angle is 0 degrees (i.e., primary pin shoulder 256 is perpendicular to the pin axis 132).

The secondary shoulder 260 comprises a secondary box shoulder 262 at a secondary box angle with respect to the box axis 112; and a secondary pin shoulder 266 at a secondary pin angle with respect to the pin axis 132. See also FIG. 1A: 112 & FIG. 1B: 132 (showing box and pin made-up).

In a standard double-shoulder connection, the secondary box angle is 0 degrees (i.e., secondary box shoulder 262 is perpendicular to the box axis 112) and the secondary pin angle is 0 degrees (i.e., secondary pin shoulder 266 is perpendicular to the pin axis 132).

FIG. 2B illustrates a detailed view C1 in FIG. 2A, showing the standard primary shoulder connection. As shown in FIG. 2B, the primary box angle is 0 degrees and the primary pin angle is 0 degrees.

FIG. 2C illustrates a detailed view C2 in FIG. 2A, showing the standard secondary shoulder connection. As shown in FIG. 2C, the secondary box angle is 0 degrees and the secondary pin angle is 0 degrees.

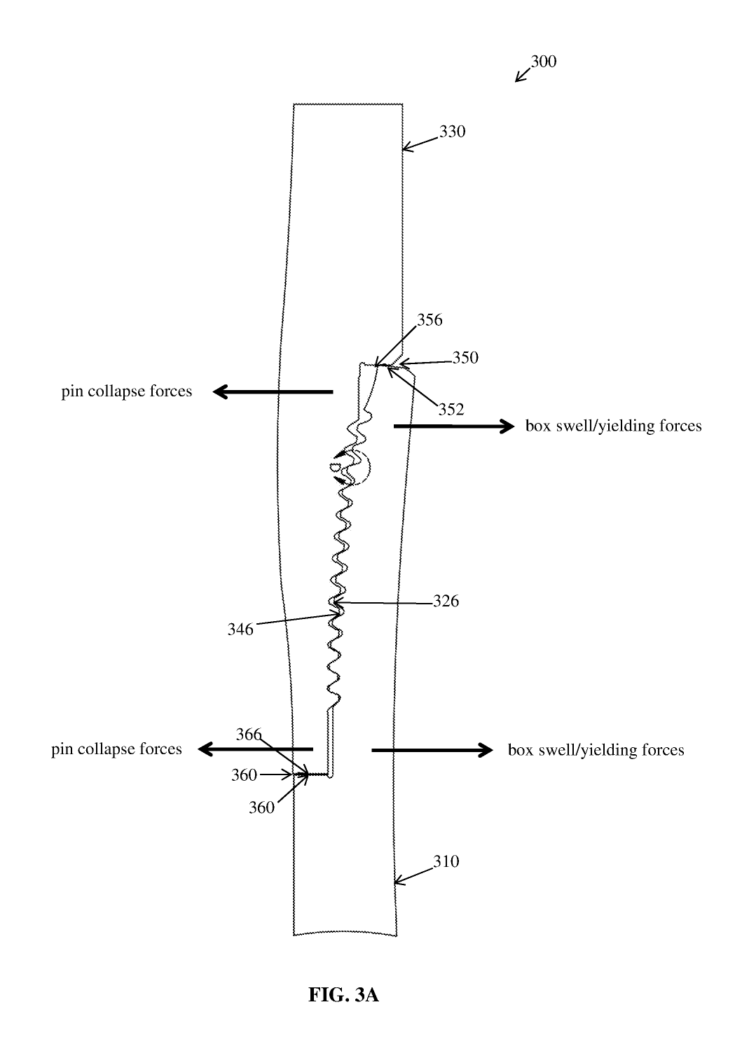

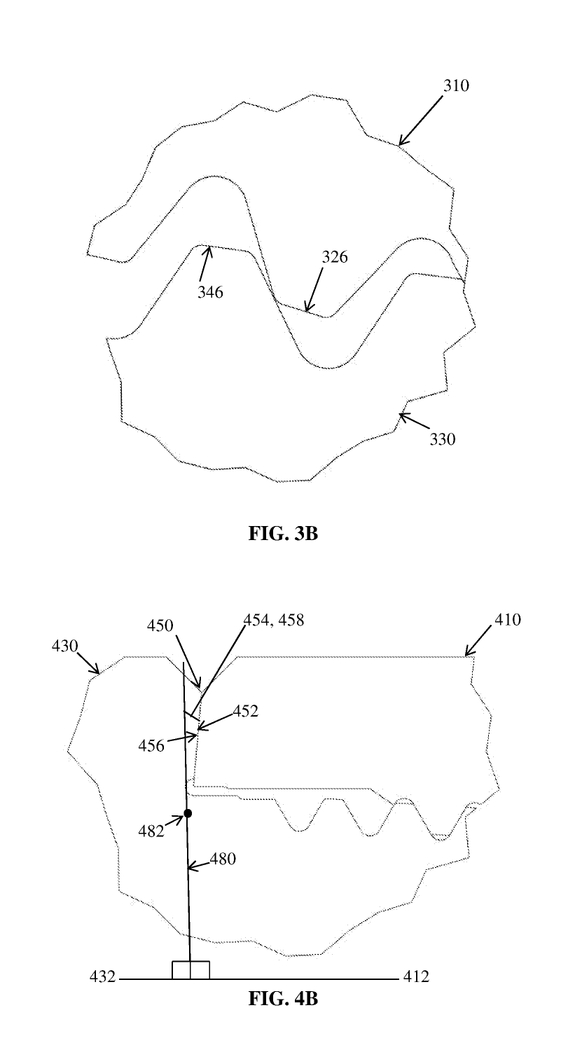

As discussed in the “Background of the Invention” section, standard (typical) double-shoulder connections 300 and standard (typical) single-shoulder connections suffer from the problem of box “swell” (e.g., box material yields) due to tapered threads, included thread profile angle (see FIG. 11: 1150) and high generated axial compressive loads. FIG. 3A illustrates a cross-sectional view of the standard (typical) double-shoulder connection 200, 300 shown in FIG. 2A, showing an exaggerated deformation of the box connection 210, 310 and the pin connection 230, 330 for clarity purposes.

Standard (typical) double shoulder connection 200, 300 and standard (typical single shoulder connections suffer from the problem of box swell (e.g., box material yields). As shown in FIG. 3A, the box swell/yielding forces force the primary shoulder 350 of the box connection 310 outward such that the box connection 210, 310 swells (e.g., box material yields), causing deformation of and/or permanent damage to the box connection 210, 310.

Standard (typical) double-shoulder connections 200, 300 and standard (typical) single-shoulder connections also suffer from the problem of pin collapse. As shown in FIG. 3A, the pin collapse forces push a portion of the pin nose inward, causing deformation of and/or permanent damage to the pin connection 230, 330.

Further, the cyclic box swell/yielding forces are transmitted into, for example, a first pin thread and a second pin thread resulting in damage to the first pin thread and the second pin thread (i.e., initially causing cracks at the root of the pin threads and, ultimately, failure of the pin threads). This combination of box swell (e.g., box material yields) and pin collapse can lead to misalignment of the box threads 226, 326 and the pin threads 246, 346, as well as permanent damage to the box connection 210, 310 and/or the pin connection 230, 330. FIG. 3B illustrates a detailed view D in FIG. 3A, showing a thread misalignment. As shown in FIG. 3B, the box threads 226, 326 are misaligned with the pin threads 246, 346, causing damage to the box threads 226, 326 and/or the pin threads 246, 346.

In addition, this combination of box swell and pin collapse, in conjunction with high alternating axial, torsional, and bending loads, can lead to premature fatigue failure (e.g., material yields) of the standard (typical) double-shoulder connection 200, 300 and the standard (typical) single-shoulder connection, damage to the box threads 226, 326 and/or the pin threads 246, 346, and permanent deformation of the box connection 210, 310 and/or the pin connection 230, 330.

### Improved Double-Shoulder Connections

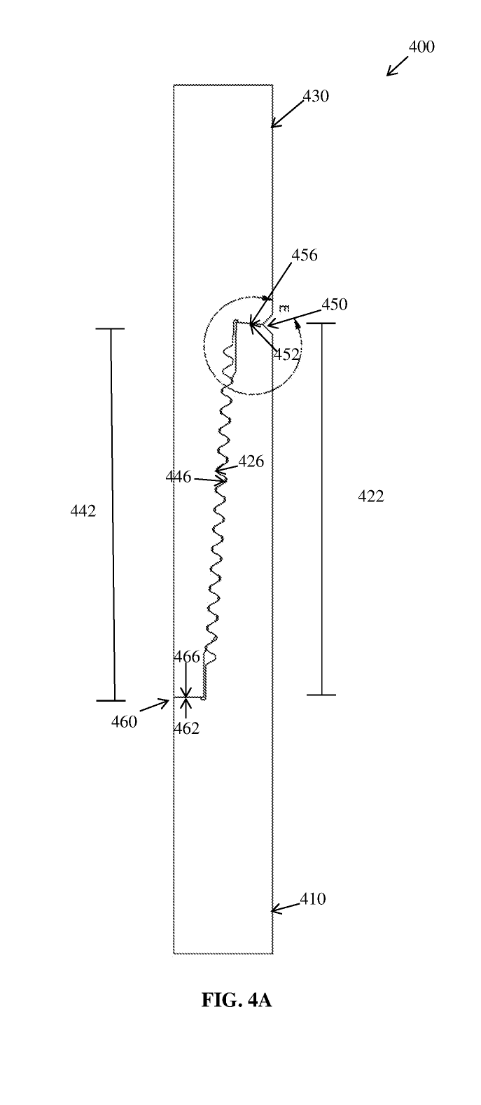

An angled primary shoulder 450 reduces box swell (e.g., box materials yields) and provides better alignment of the box threads 426 and pin threads 446 in an improved double-shoulder connection 400. The angled primary shoulder 450 provides an avenue for compressive forces and elevated torques while drilling to move axially and inward into the pin connection, reducing box swell. The angled primary shoulder 450 also balances compressive forces between the primary and secondary shoulder connections. FIG. 4A illustrates a cross-sectional view of an improved double-shoulder connection 400 with an angled primary shoulder 450 and a standard secondary shoulder 460 according to an embodiment of the present invention. As shown in FIG. 4A, the improved double-shoulder connection 400 comprises a box connection 410 having a box axis (centerline) 412, a pin connection 430 having a pin axis (centerline) 432, a primary shoulder 450, and a secondary shoulder 460.

In an embodiment, the primary shoulder 450 comprises a primary box shoulder 452 at a primary box angle 454 with respect to a first perpendicular 480 to the box axis 412 at a first end point 482 of the box connection; and a primary pin shoulder 456 at a primary pin angle 458 with respect to a first perpendicular 480 to the pin axis 432 at the first end point 482 of the pin connection. See also FIG. 1A: 112 & FIG. 1B: 132 (showing box and pin made up). In an embodiment, the first end point 482 may be equal to a datum intersection, as discussed below.

In an embodiment, the primary box shoulder 452 may be any suitable shape. For example, suitable shapes include, but are not limited to, conical shaped, cylindrical shaped, conical-cylindrical shaped, and variations thereof. In an embodiment, the primary box shoulder 452 may be conical shaped (outside of cone, male).

In an embodiment, the primary pin shoulder 456 may be any suitable shape. For example, suitable shapes include, but are not limited to, conical shaped, cylindrical shaped, conical-cylindrical shaped, and variations thereof. In an embodiment, the primary pin shoulder 456 may be conical shaped (inside of cone, female).

In an embodiment, the primary box shoulder 452 may be any suitable profile. For example, suitable profiles include, but are not limited to angled profiles. In an embodiment, the primary box shoulder 452 may be an angled profile defined by a primary box angle 454, as discussed below.

In an embodiment, the primary box angle 454 may be from greater than about 0 degrees to less than or equal to about 15 degrees, and any range or value there between. In an embodiment, the primary box angle 454 may be from greater than about 0 degrees to less than or equal to about 10 degrees. In an embodiment, the primary box angle 454 may be about 5 degrees.

In an embodiment, the primary pin shoulder 456 may be any suitable profile. For example, suitable profiles include, but are not limited to, angled profiles. In an embodiment, the primary pin shoulder 456 may be an angled profile defined by a primary pin angle 458, as discussed below.

In an embodiment, the primary pin angle 458 may be from greater than about 0 degrees to less than or equal to about 15 degrees, and any range or value there between. In an embodiment, the primary pin angle 458 may be from greater than about 0 degrees to less than or equal to about 10 degrees. In an embodiment, the primary pin angle 458 may be about 5 degrees.

In an embodiment, the primary box angle 454 may be about equal to the primary pin angle 458 to form a first seal.

In an embodiment, the primary box angle 454 may be slightly different from the primary pin angle 458 to form a first seal. In an embodiment, the first seal may be a gas-tight seal.

FIG. 4B illustrates a detailed view E in FIG. 4A, showing the angled primary shoulder 450 according to an embodiment of the present invention. As shown in FIG. 4B, the primary box angle may be from greater than about 0 degrees to less than or equal to about 15 degrees, and the primary pin angle may be from greater than about 0 degrees to less than or equal to about 15 degrees. See also FIG. 2B (showing a standard primary shoulder 250).

In an embodiment, the secondary shoulder 460 comprises a secondary box shoulder 462 at a secondary box angle with respect to a second perpendicular to the box axis at a second end point of the box connection; and a secondary pin shoulder 466 at a secondary pin angle with respect to the second perpendicular to the pin axis at the second end point of the pin connection. See also FIG. 1A: 112 & FIG. 1B: 132 (showing box and pin made-up).

In an embodiment, the secondary box shoulder 462 may be any suitable shape. For example, suitable shapes include, but are not limited to, conical shaped, cylindrical shaped, conical-cylindrical shaped, and variations thereof. In an embodiment, the secondary box shoulder 462 may be conical shaped (outside of cone, male).

In an embodiment, the secondary pin shoulder 466 may be any suitable shape. For example, suitable shapes include, but are not limited to, conical shaped, cylindrical shaped, conical-cylindrical shaped, and variations thereof. In an embodiment, the secondary pin shoulder 466 may be conical shaped (inside of cone, female).

In an embodiment, the secondary box shoulder 462 may be any suitable profile. For example, suitable profiles include, but are not limited to angled profiles. In an embodiment, the secondary box shoulder 462 may be an angled profile defined by a secondary box angle, as discussed below.

In an embodiment, the secondary box angle may be from greater than or equal to about 0 degrees to less than or equal to about 15 degrees, and any range or value there between. In an embodiment, the secondary box angle may be from greater than or equal to about 0 degrees to less than or equal to about 10 degrees. In an embodiment, the secondary box angle may be about 5 degrees. In an embodiment, the secondary box angle may be about 0 degrees. See FIG. 4A-4B.

In an embodiment, the secondary pin shoulder 466 may be any suitable profile. For example, suitable profiles include, but are not limited to, angled profiles. In an embodiment, the secondary pin shoulder 466 may be an angled profile defined by a primary pin angle, as discussed below.

In an embodiment, the secondary pin angle may be from greater than to equal to about 0 degrees to less than or equal to about 15 degrees, and any range or value there between. In an embodiment, the secondary pin angle may be from greater than or equal to about 0 degrees to less than or equal to about 10 degrees. In an embodiment, the secondary pin angle may be about 5 degrees. In an embodiment, the secondary pin angle may be about 0 degrees. See FIGS. 4A-4B.

In a standard secondary shoulder 460, the secondary box angle is 0 degrees (i.e., secondary box shoulder 462 is perpendicular to the box axis 412) and the secondary pin angle is 0 degrees (i.e., secondary pin shoulder 466 is perpendicular to the pin axis 432).

In an embodiment, the secondary box angle may be about equal to the secondary pin angle to form a torque shoulder.

In an embodiment, the secondary box angle may be slightly different from the secondary pin angle to form a torque shoulder that is a second seal. In an embodiment, the torque shoulder or the second seal may be a gas-tight seal.

FIG. 4A illustrates the standard secondary shoulder 460 according to an embodiment of the present invention. As shown in FIG. 4A, the secondary box angle is 0 degrees; and the secondary pin angle is 0 degrees. See also FIG. 2C (showing a standard secondary shoulder).

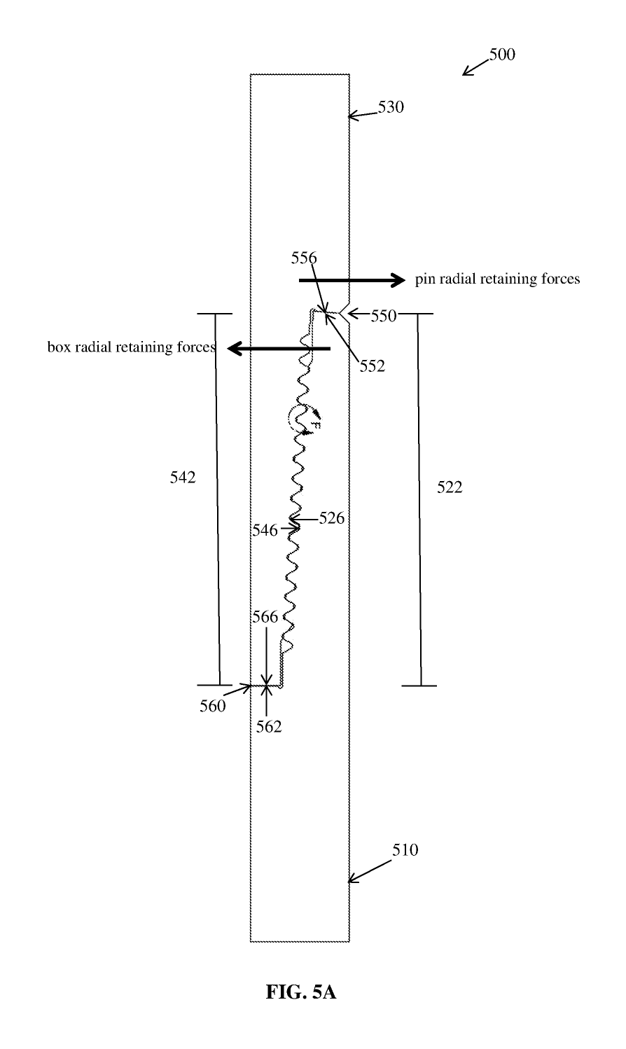

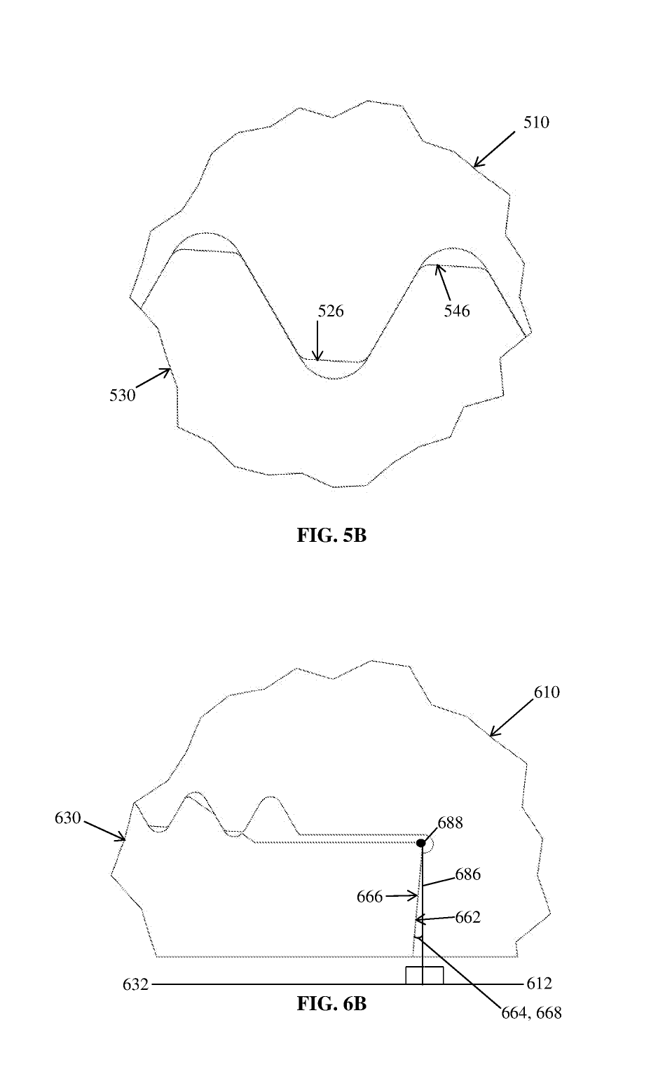

As discussed above, an angled primary shoulder 450, 550 reduces box swell (e.g., box materials yields) and provides better alignment of the box threads 426, 526 and pin threads 446, 546 in an improved double-shoulder connection 400, 500. The angled primary shoulder 450, 550 provides an avenue for compressive forces and elevated torques while drilling to move axially and radially (i.e., inward) into the pin connection, reducing box swell (e.g., box material yields). The angle primary shoulder 450, 550 also balances compressive forces between the primary and secondary shoulder connections. FIG. 5A illustrates a cross-sectional view of the improved double-shoulder connection 400, 500 of FIG. 4A, showing box radial retaining forces and pin radial retaining forces. As shown in FIG. 5A, the angled primary shoulder 450, 550 reduces the box swell/yielding forces shown in FIG. 3A. See also FIG. 3A (showing a standard primary shoulder 350). In other words, the box radial retaining forces generated by the angled primary shoulder 450, 550 reduce the box swell/yielding forces, reducing box swell (e.g., box material yield).

As shown in FIG. 5A, the angled primary shoulder 450, 550 also reduces the pin collapse forces shown in FIG. 3A. See also. FIG. 3A (showing a standard primary shoulder 350). In other words, the pin radial retaining forces generated by the angled primary shoulder 450, 550 reduce the pin collapse forces, reducing pin collapse.

As discussed with respect to the standard double-shoulder connection, the combination of box swell and pin collapse can lead to misalignment of the box threads 426, 526 and the pin threads 446, 546, as well as permanent damage to the box connection 410, 510 and/or the pin connection 430, 530. See also FIGS. 3A (showing a standard primary shoulder 350) & 3B (showing misaligned threads 326, 346). FIG. 5B illustrates a detailed view F in FIG. 5A, showing improved thread alignment. As shown in FIG. 5B, the box threads 526 are aligned with the pin threads 546.

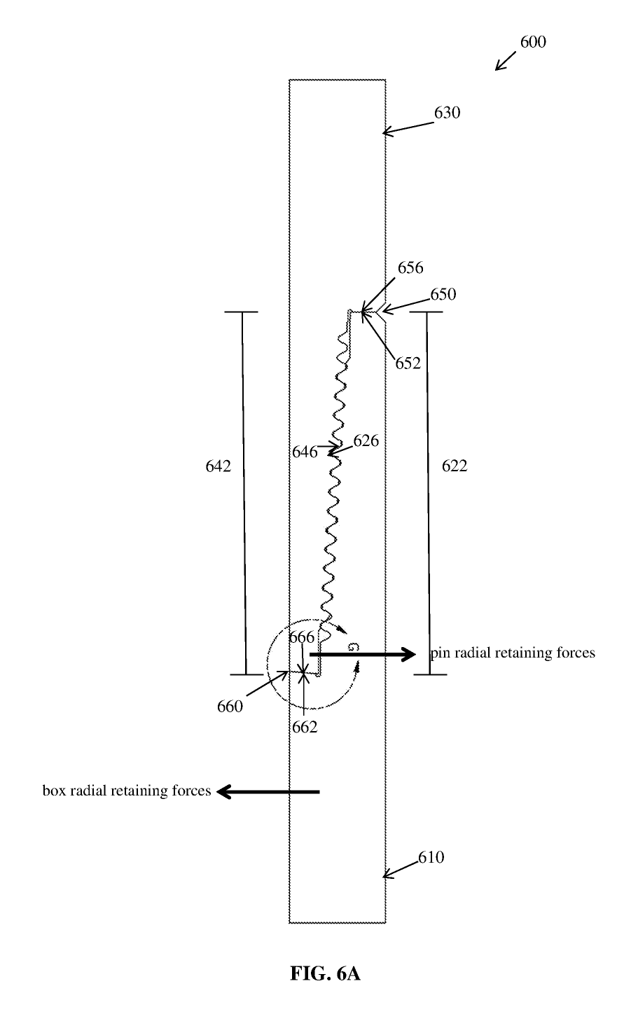

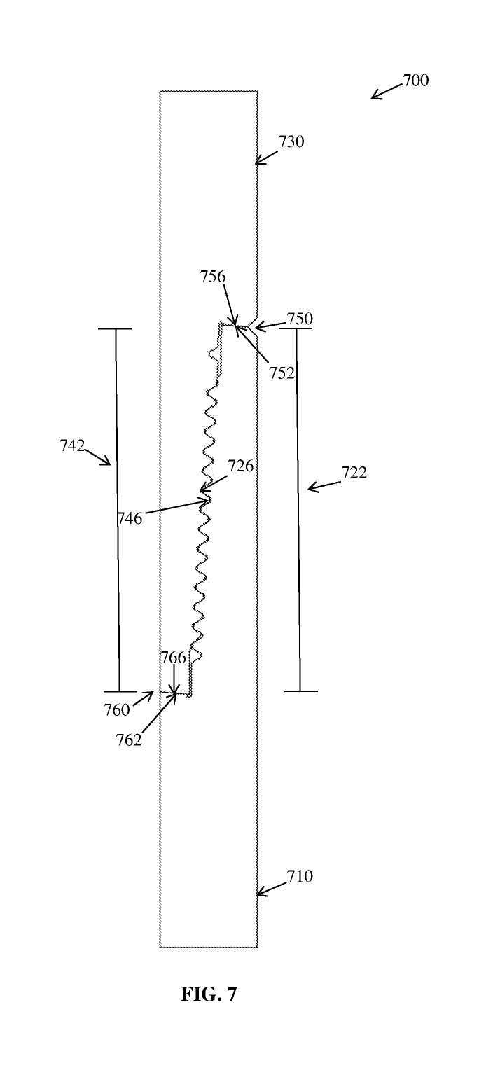

FIG. 6A illustrates a cross-sectional view of an improved double-shoulder connection 600 with a standard primary shoulder 650 and an angled secondary shoulder 660 according to an embodiment of the present invention; and FIG. 7 illustrates a cross-sectional view of an improved double-shoulder connection with an angled primary shoulder and an angled secondary shoulder according to an embodiment of the present invention. As shown in FIGS. 6A and 7, the improved double-shoulder connection 600, 700 comprises a box connection 610, 710 having a box axis (centerline) 612, a pin connection 630, 730 having a pin axis (centerline) 632, a primary shoulder 650, 750, and a secondary shoulder 660, 760.

In an embodiment, the primary shoulder 650, 750 comprises a primary box shoulder 652, 752 at a primary box angle with respect to a first perpendicular to the box axis 612 at a first end point of the box connection; and a primary pin shoulder 656, 756 at a primary pin angle with respect to the first perpendicular to the pin axis 632 at the first end point of the pin connection. See also FIG. 1A: 112 & FIG. 1B: 132 (showing box and pin made-up). In an embodiment, the first end point may be equal to a datum intersection, as discussed below.

In an embodiment, the primary box shoulder 652, 752 may be any suitable shape. For example, suitable shapes include, but are not limited to, conical shaped, cylindrical shaped, conical-cylindrical shaped, and variations thereof. In an embodiment, the primary box shoulder 752 may be conical shaped (outside of cone, male).

In an embodiment, the primary pin shoulder 656, 756 may be any suitable shape. For example, suitable shapes include, but are not limited to, conical shaped, cylindrical shaped, conical-cylindrical shaped, and variations thereof. In an embodiment, the primary pin shoulder 756 may be conical shaped (inside of cone, female).

In an embodiment, the primary box shoulder 652, 752 may be any suitable profile. For example, suitable profiles include, but are not limited to angled profiles. In an embodiment, the primary box shoulder 652, 752 may be an angled profile defined by a primary box angle, as discussed below.

In an embodiment, the primary box angle may be from greater than or equal to about 0 degrees to less than or equal to about 15 degrees, and any range or value there between. See FIG. 7. In an embodiment, the primary box angle may be from greater than or equal to about 0 degrees to less than or equal to about 10 degrees. In an embodiment, the primary box angle may be about 5 degrees. In an embodiment, the primary box angle is about 0 degrees. See FIGS. 6A-6B.

In an embodiment, the primary pin shoulder 656, 756 may be any suitable profile. For example, suitable profiles include, but are not limited to, angled profiles. In an embodiment, the primary pin shoulder 656, 756 may be an angled profile defined by a primary pin angle, as discussed below.

In an embodiment, the primary pin angle may be from greater than or equal to about 0 degrees to less than or equal to about 15 degrees, and any range or value there between. See FIG. 7. In an embodiment, the primary pin angle may be from greater than or equal to about 0 degrees to less than or equal to about 10 degrees. In an embodiment, the primary pin angle may be about 5 degrees. In an embodiment, the primary pin angle may be about 0 degrees. See FIGS. 6A-6B.

In a standard primary shoulder 650, the primary box angle is 0 degrees (i.e., primary box shoulder 652 is perpendicular to the box axis 112) and the primary pin angle is 0 degrees (i.e., primary pin shoulder 656 is perpendicular to the pin axis 132). See FIGS. 6A-6B.

In an embodiment, the primary box angle may be about equal to the primary pin angle to form a first seal.

In an embodiment, the primary box angle may be slightly different from the primary pin angle to form a first seal. In an embodiment, the first seal may be a gas-tight seal.

In an embodiment, the secondary shoulder 660, 760 comprises a secondary box shoulder 662, 762 at a secondary box angle 664 with respect to a second perpendicular 686 to the box axis 612 at a second end point 688 of the box connection; and a secondary pin shoulder 666, 766 at a secondary pin angle 668 with respect to the second perpendicular 686 to the pin axis 632 at the second end point 688 of the pin connection. See also FIG. 1A: 112 & FIG. 1B: 132 (showing box and pin made-up).

In an embodiment, the secondary box shoulder 662, 762 may be any suitable shape. For example, suitable shapes include, but are not limited to, conical shaped, cylindrical shaped, conical-cylindrical shaped, and variations thereof. In an embodiment, the secondary shoulder 662, 762 may be conical shaped (outside of cone, male).

In an embodiment, the secondary pin shoulder 666, 766 may be any suitable shape. For example, suitable shapes include, but are not limited to, conical shaped, cylindrical shaped, conical-cylindrical shaped, and variations thereof. In an embodiment, the secondary pin shoulder 666, 766 may be conical shaped (inside of cone, female).

In an embodiment, the secondary box shoulder 662, 762 may be any suitable profile. For example, suitable profiles include, but are not limited to, angled profiles. In an embodiment, the secondary box shoulder 662, 762 may be an angled profile defined by a secondary box angle 664, as discussed below.

In an embodiment, the secondary box angle 664 may be from greater than or equal to about 0 degrees to less than or equal to about 15 degrees, and any range or value there between. See also FIG. 7. In an embodiment, the secondary box angle 664 may be from greater than or equal to about 0 degrees to less than or equal to about 10 degrees. In an embodiment, the secondary box angle 664 may be about 5 degrees.

In an embodiment, the secondary pin shoulder 666, 766 may be any suitable profile. For example, suitable profiles include, but are not limited to, angled profiles. In an embodiment, the secondary pin shoulder 666, 766 may be an angled profile defined by a secondary pin angle 668, as discussed below.

In an embodiment, the secondary pin angle 668 may be from greater than or equal to about 0 degrees to less than or equal to about 15 degrees, and any range or value there between. See also FIG. 7. In an embodiment, the secondary pin angle 668 may be from greater than or equal to about 0 degrees to less than or equal to about 10 degrees. In an embodiment, the secondary pin angle 668 may be about 5 degrees.

In an embodiment, the secondary box angle 664 may be about equal to the secondary pin angle 668 to form a torque shoulder.

In an embodiment, the secondary box angle 664 may be slightly different from the secondary pin angle 668 to form a torque shoulder. In an embodiment, the torque shoulder may be a gas-tight seal.

FIG. 6B illustrates a detailed view G in FIG. 6A, showing the angled secondary shoulder 660 according to an embodiment of the present invention. As shown in FIG. 6B, the secondary box angle 664 may be from greater than or equal to about 0 degrees to less than or equal to about 15 degrees; and the secondary pin angle 668 may be from greater than or equal to about 0 degrees to less than or equal to about 15 degrees.

As discussed above, an angled secondary shoulder 660 reduces box swell (e.g., box materials yields) in an improved double-shoulder connection 600. The angled secondary shoulder 660 provides an avenue for compressive forces and elevated torques while drilling to move axially and radially (i.e., inward) into the pin connection, reducing box swell (e.g., box material yields). The angled secondary shoulder 660 also balances compressive forces between the primary and secondary shoulder connections. FIG. 6A illustrates a cross-sectional view of the improved double-shoulder connection 600, showing box radial retaining forces and pin radial retaining forces. As shown in FIG. 6A, the angled secondary shoulder 660 reduces the box swell/yielding forces shown in FIG. 3A. See also FIG. 3A (showing a standard secondary shoulder 360). In other words, the box radial retaining forces generated by the angled secondary shoulder 660 reduce the box swell/yielding forces, reducing box swell (e.g., box material yields).

As shown in FIG. 6A, the angled secondary shoulder 660 also reduces the pin collapse forces shown in FIG. 3A. See also. FIG. 3A (showing a standard secondary shoulder 360). In other words, the pin radial retaining forces generated by the angled secondary shoulder 660 reduce the pin collapse forces, reducing pin nose diving.

As discussed with respect to the standard double-shoulder connection, the combination of box swell and pin collapse can lead to permanent damage to the box connection 610 and/or the pin connection 630 as shown in FIG. 3A. See also FIG. 3A (showing a standard secondary shoulder 360).

In an embodiment, the improved double-shoulder connection 400, 500, 600, 700, 1200, 1400 may be made of any suitable material. For example, suitable materials include, but are not limited to, low alloy steels (e.g., 4140, 4145, 4330, etc.), stainless steels (e.g., 17-4, 304, 316, etc.), super alloys (e.g., Inconel), titanium alloys (e.g., Ti-6Al-4V, Ti-6Al-6V-2Sn, etc.), copper alloys (e.g., Beryllium copper), cobalt alloys (e.g., Stellite), aluminum alloys (e.g., 2024, 6061,7075, etc.), and combinations and variations thereof. In an embodiment, the improved double-shoulder connection 400, 500, 600, 700, 1200, 1400 may be low alloy steels or stainless steels.

In an embodiment, the improved double-shoulder connection 400, 500, 600, 700, 1200, 1400 may be applied to any suitable product. For example, suitable products include, but are not limited to, drill pipe (DP), heavy weight drill pipe (HWDP), drill collars (DC), pup joints, crossover subs, saver subs, bit subs, float subs, pump-in subs, inside blowout preventers (IBOP), top drive shafts, top drive valves, safety valves, kelly valves, hoisting equipment (e.g., lift subs, lift plugs), swivels, fishing tools, mud motors, rotary steerable tools, drill bits, directional drilling bottom hole assembly (BHA) components, measurement while drilling (MWD) components, logging while drilling (LWD) components, well cleanout tools (e.g., brushes, magnets), completion tools, and combinations and variations thereof. In an embodiment, the improved double-shoulder connection 400, 500, 600, 700, 1200, 1400 may be applied to drill pipe (DP) or heavy weight drill pipe (HWDP) or drill collars (DC) or pup joints.

In an embodiment, the improved double-shoulder connection 400, 500, 600, 700, 1200, 1400 may be applied to any suitable diameter drill pipe (DP). For example, suitable diameter DP includes, but is not limited to, from about 2⅜-inch outer diameter (OD) to about 7⅝-inch OD, and any range or value there between.

In an embodiment, the improved double-shoulder connection 400, 500, 600, 700, 1200, 1400 may be applied to any suitable heavy weight diameter drill pipe (HWDP). For example, suitable diameter HWDP includes, but is not limited to, from about 2⅞-inch OD to about 6⅝-inch OD, and any range or value there between.

In an embodiment, the improved double-shoulder connection 400, 500, 600, 700, 1200, 1400 may be applied to any suitable drill collars (DC). For example, suitable diameter DC includes, but is not limited to, from about 3⅛-inch OD to about 11-inch OD, and any range or value there between.

In an embodiment, the improved double-shoulder connection 400, 500, 600, 700, 1200, 1400 may be applied to any suitable pup joints. For example, suitable diameter pup joints includes, but is not limited to, from about 2⅜-inch OD to about 7⅝-inch OD, and any range or value there between.

### Improved Single-Shoulder Connections

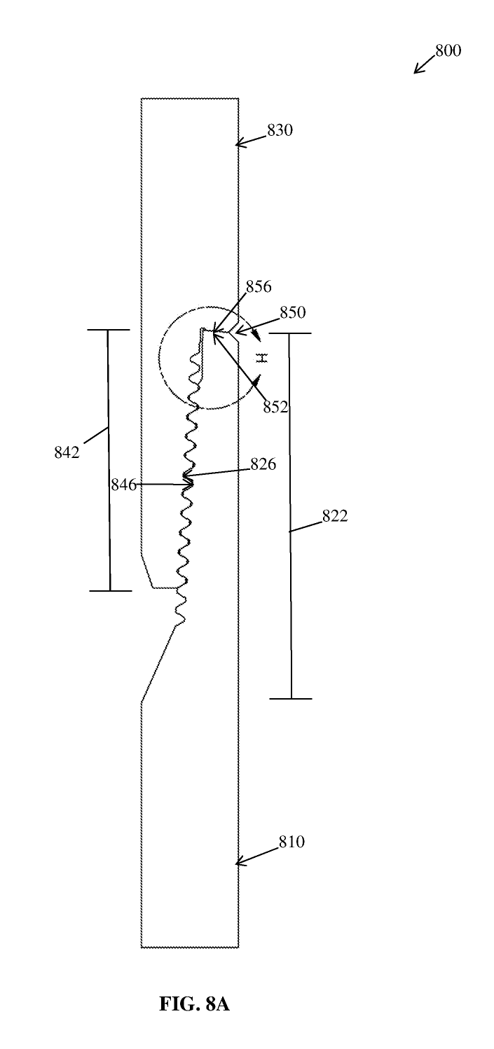

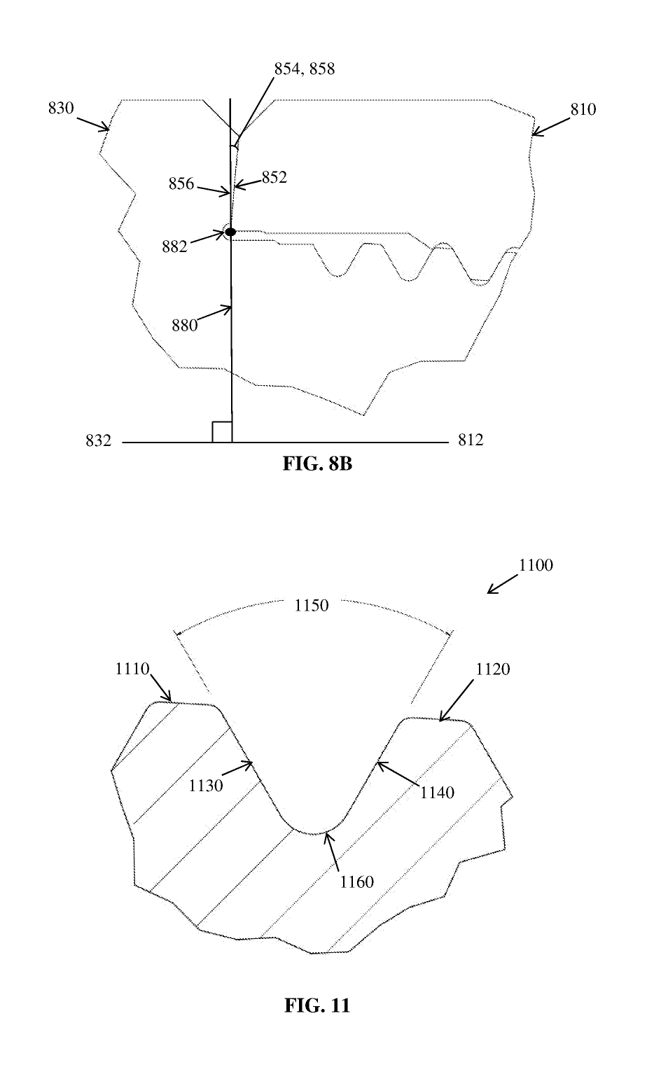

Similar to the double-shoulder connections 400, 500, 600, 700, 1200, 1400 discussed above, an angled primary shoulder 850, 950, 1050, 1250 reduces box swell (e.g., box material yields) and provides better alignment of the box threads 826, 926, 1026 and pin threads 846, 946, 1046 in an improved single-shoulder connection 800, 900, 1000, 1200. The angled primary shoulder 850, 950, 1050 provides an avenue for compressive forces and elevated torques while drilling to move axially and radially (i.e., inward) into the pin connection, reducing box swell. FIGS. 8A, 9 and 10 illustrate a cross-sectional view of an improved single-shoulder connection 800, 900, 1000 with an angled primary shoulder 850, 950, 1050 according to an embodiment of the present invention. As shown in FIGS. 8A, 9 and 10, the improved single-shoulder connection 800, 900, 1000 comprises a box connection 810, 910, 1010 having a box axis (centerline) 812, a pin connection 830, 930, 1030 having a pin axis (centerline) 832, and a primary shoulder 850, 950, 1050.

In an embodiment, the primary shoulder 850 comprises a primary box shoulder 852 at a primary box angle 854 with respect to a first perpendicular 880 to the box axis 812 at a first end point 882 of the box connection; and a primary pin shoulder 856 at a primary pin angle 858 with respect to the first perpendicular 880 to the pin axis 832 at the first end point 882 of the pin connection. See also FIG. 1A: 112 & FIG. 1B: 132 (showing box and pin made-up). In an embodiment, the first end point 882 may be equal to a datum intersection, as discussed below.

In an embodiment, the primary box shoulder 852 may be any suitable shape. For example, suitable shapes include, but are not limited to, conical shaped, cylindrical shaped, conical-cylindrical shaped, and variations thereof. In an embodiment, the primary shoulder 852 may be conical shaped (outside of cone, male).

In an embodiment, the primary pin shoulder 856 may be any suitable shape. For example, suitable shapes include, but are not limited to, conical shaped, cylindrical shaped, conical-cylindrical shaped, and variations thereof. In an embodiment, the primary pin shoulder 856 may be conical shaped (inside of cone, female).

In an embodiment, the primary box shoulder 852 may be any suitable profile. For example, suitable profiles include, but are not limited to, angled profiles. In an embodiment, the primary box shoulder 852 may be an angled profile defined by a primary box angle 854, as discussed below.

In an embodiment, the primary box angle 854 may be from greater than about 0 degrees to less than or equal to about 15 degrees, and any range or value there between. In an embodiment, the primary box angle 854 may be from greater than about 0 degrees to less than or equal to about 10 degrees. In an embodiment, the primary box angle 854 may be about 5 degrees.

In an embodiment, the primary pin shoulder 856 may be any suitable profile. For example, suitable profiles include, but are not limited to, angled profiles. In an embodiment, the primary pin shoulder 856 may be an angled profile defined by a primary pin angle 858, as discussed below.

In an embodiment, the primary pin angle 858 may be from greater than about 0 degrees to less than or equal to about 15 degrees, and any range or value there between. In an embodiment, the primary pin angle 858 may be from greater than about 0 degrees to less than or equal to about 10 degrees. In an embodiment, the primary pin angle 858 may be about 5 degrees.

In an embodiment, the primary box angle 854 may be about equal to the primary pin angle 858 to form a first seal.

In an embodiment, the primary box angle 854 may be slightly different from the primary pin angle 858 to form a first seal. In an embodiment, the first seal may be a gas-tight seal.

FIG. 8B illustrates a detailed view H in FIG. 8A, showing the angled primary shoulder 850 according to an embodiment of the present invention. As shown in FIG. 8B, the primary box angle 854 may be from greater than about 0 degrees to less than or equal to about 15 degrees; and the primary pin angle 858 may be from greater than about 0 degrees to less than or equal to about 15 degrees. See also FIG. 2B (showing a standard primary shoulder 250).

In an embodiment, the improved single-shoulder connection 800, 900, 1000, 1200 may be made of any suitable material. For example, suitable materials include, but are not limited to, low alloy steels (e.g., 4140, 4145, 4330, etc.), stainless steels (e.g., 17-4, 304, 316, etc.), super alloys (e.g., Inconel), titanium alloys (e.g., Ti-6Al-4V, Ti-6Al-6V-2Sn, etc.), copper alloys (e.g., Beryllium copper), cobalt alloys (e.g., Stellite), aluminum alloys (e.g., 2024, 6061, 7075, etc.), and combinations and variations thereof. In an embodiment, the improved single-shoulder connection 800, 900, 1000, 1200 may be low alloy steels or stainless steels.

In an embodiment, the improved single-shoulder connection 800, 900, 1000, 1200 may be applied to any suitable product. For example, suitable products include, but are not limited to, drill pipe (DP), heavy weight drill pipe (HWDP), drill collars (DC), pup joints, crossover subs, saver subs, bit subs, float subs, pump-in subs, inside blowout preventers (IBOP), top drive shafts, top drive valves, safety valves, kelly valves, hoisting equipment (e.g., lift subs, lift plugs), swivels, fishing tools, mud motors, rotary steerable tools, drill bits, directional drilling bottom hole assembly (BHA) components, measurement while drilling (MWD) components, logging while drilling (LWD) components, well cleanout tools (e.g., brushes, magnets), completion tools and combinations and variations thereof. In an embodiment, the improved single-shoulder connection 800, 900, 1000, 1200 may be applied to drill pipe (DP) or heavy weight drill pipe (HWDP) or drill collars (DC) or pup joints.

In an embodiment, the improved single-shoulder connection 800, 900, 1000, 1200 may be applied to any suitable diameter drill pipe (DP). For example, suitable diameter DP include, but are not limited to, from about 2⅜-inch outer diameter (OD) to about 7⅝-inch OD, and any range or value there between.

In an embodiment, the improved single-shoulder connection 800, 900, 1000, 1200 may be applied to any suitable heavy weight diameter drill pipe (HWDP). For example, suitable diameter HWDP include, but are not limited to, from about 2⅞-inch OD to about 6⅝-inch OD, and any range or value there between.

In an embodiment, the improved single-shoulder connection 800, 900, 1000, 1200 may be applied to any suitable drill collars (DC). For example, suitable diameter DC include, but are not limited to, from about 3⅛-inch OD to about 11-inch OD, and any range or value there between.

In an embodiment, the improved single-shoulder connection 800, 900, 1000, 1200 may be applied to any suitable pup joints. For example, suitable diameter pup joints include, but are not limited to, from about 2⅜-inch OD to about 7⅝-inch OD, and any range or value there between.

Optional Box Stress Relief Groove and/or Pin Stress Relief Groove

An optional box stress relief groove 980 and/or an optional pin stress relief groove 990 may be applied to a double-shoulder connection 400, 500, 600, 700, 1200, 1400 or a single-shoulder connection 800, 900, 1000, 1200 at portion(s) where premature fatigue failure of the double-shoulder connection or the single-shoulder connection may occur as a result of alternating axial, torsional and bending loads, as discussed above with respect to FIGS. 2A-3B.

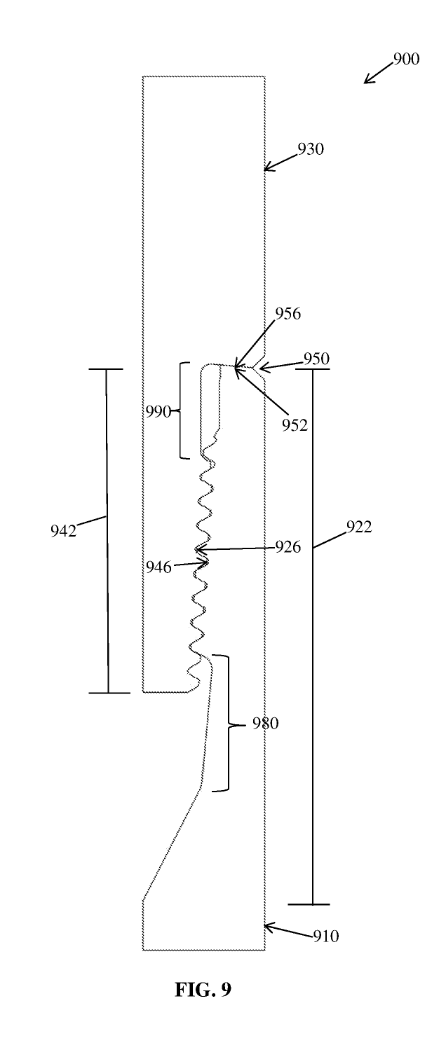

FIG. 9 illustrates a cross-sectional view of an improved single-shoulder connection 900 with an optional box stress relief groove 980 and an optional pin stress relief groove 990 according to an embodiment of the present invention. As shown in FIG. 9, the optional box stress relief groove 980 and/or the optional pin stress relief groove 990 removes unengaged threads in potentially stressed portions of the single-shoulder connection 900 so that any bending occurs in portions with smooth surfaces that are relatively free of stress concentrations.

Similar to FIG. 8A, FIG. 9 illustrates a cross-sectional view of an improved single-shoulder connection 900 with an angled primary shoulder 950 according to an embodiment of the present invention. As shown in FIGS. 8 and 9, the improved single-shoulder connection 800, 900 comprises a box connection 810, 910 having a box axis (centerline) 812, a pin connection 830, 930 having a pin axis (centerline) 832, and a primary shoulder 850, 950.

In an embodiment, the primary shoulder 850, 950 comprises a primary box shoulder 852, 952 at a primary box angle 854 with respect to a first perpendicular 880 to the box axis 812 at a first end point 882 of the box connection; and a primary pin shoulder 856, 956 at a primary pin angle 858 with respect to the first perpendicular 880 to the pin axis 832 at the first end point 882 of the pin connection. See also FIG. 1A: 112 & FIG. 1B: 132 (showing box and pin made-up). In an embodiment, the first end point 882 may be equal to a datum intersection, as discussed below.

### Optional Box Boreback and Pin Stress Relief Groove

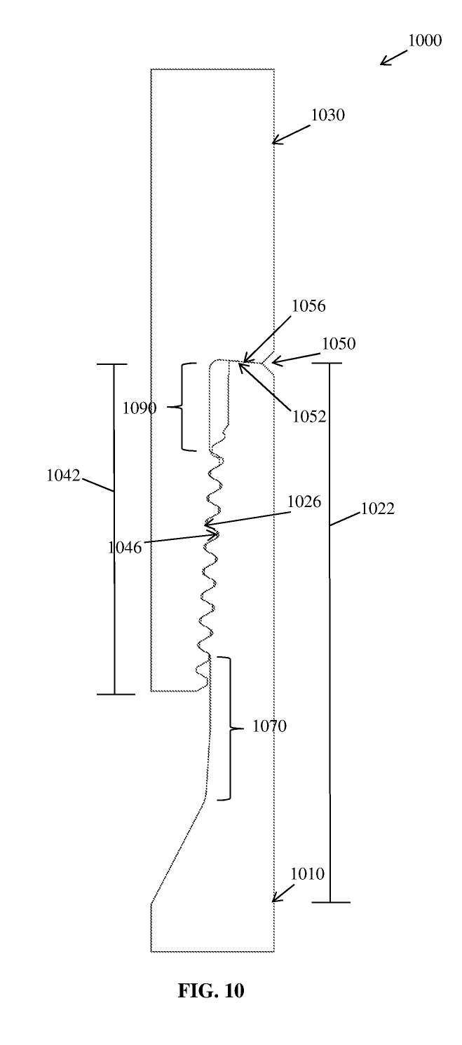

An optional box boreback 1070 may be applied to a single-shoulder connection 800, 900, 1000, 1200 at portion(s) where fatigue may occur as a result of bending; and an optional pin stress relief groove 1090 may be applied to a double-shoulder connection 400, 500, 600, 700, 1200, 1400 or a single-shoulder connection 800, 900, 1000, 1200 at portion(s) where fatigue may occur as a result of bending. FIG. 10 illustrates a cross-sectional view of an improved single-shoulder connection with an optional box boreback 1070 and an optional pin stress relief groove 1090 according to an embodiment of the present invention. As shown in FIG. 10, the optional box boreback 1070 and/or the optional pin stress relief groove 1090 removes unengaged threads in potentially stressed portions of the single-shoulder connection 1000 so that any bending occurs in portions with smooth surfaces that are relatively free of stress concentrations.

Similar to FIG. 8A, FIG. 10 illustrates a cross-sectional view of an improved single-shoulder connection 1000 with an angled primary shoulder 1050 according to an embodiment of the present invention. As shown in FIGS. 8 and 10, the improved single-shoulder connection 800, 1000 comprises a box connection 810, 1010 having a box axis (centerline) 812, a pin connection 830, 1030 having a pin axis (centerline) 832, and a primary shoulder 850, 1050.

In an embodiment, the primary shoulder 850, 1050 comprises a primary box shoulder 852, 1052 at a primary box angle 854 with respect to a first perpendicular 880 to the box axis 812 at a first end point 882 to the box connection; and a primary pin shoulder 856, 1056 at a primary pin angle 858 with respect to the first perpendicular 880 to the pin axis 832 at the first end point 882 of the pin connection. See also FIG. 1A: 112 & FIG. 1B: 132 (showing box and pin made-up). In an embodiment, the first end point 882 may be equal to a datum intersection, as discussed below.

### Types of Thread Forms

FIG. 11 illustrates a cross-sectional detailed view of a thread form 1100 according to an embodiment of the present invention. As shown in FIG. 11, the thread form 1100 comprises a first thread crest 1110, a second thread crest 1120, a first thread flank 1130, a second thread flank 1140, an included angle 1150 between the first thread flank 1130 and second thread flank 1140, and a thread root 1160.

In an embodiment, any suitable thread form 1100 may be used for the box threads 426, 526, 626, 726, 826, 926, 1026 and/or pin threads 446, 546, 646, 746, 846, 946, 1046. For example, suitable shapes include, but are not limited to, circular, square, triangular, trapezoidal and variations thereof. In an embodiment, the thread form 1100 may be triangle shaped or a variation thereof.

For example, any suitable shape for the first thread crest 1110 and/or the second thread crest 1120 may be used for the box threads 426, 526, 626, 726, 826, 926, 1026 and/or pin threads 446, 546, 646, 746, 846, 946, 1046. For example, suitable shapes include, but are not limited to, circular, square, triangular, trapezoidal and variations thereof. In an embodiment, the first thread crest 1110 and/or the second thread crest 1120 may be triangle shaped or a variation thereof.

For example, any suitable shape for the first thread flank 1130 and/or the second thread flank 1140 may be used for the box threads 426, 526, 626, 726, 826, 926, 1026 and/or pin threads 446, 546, 646, 746, 846, 946, 1046. For example, suitable shapes include, but are not limited to, concave, convex, straight and combinations or variations thereof.

In an embodiment, any suitable shape for the thread root 1160 may be used for the box threads 426, 526, 626, 726, 826, 926, 1026 and/or pin threads 446, 546, 646, 746, 846, 946, 1046. For example, suitable shapes include, but are not limited to, circular, square, triangular, trapezoidal and variations thereof. In an embodiment, the thread root 1160 may be triangle shaped or a variation thereof.

In an embodiment, any suitable included angle 1150 may be used for the box threads 426, 526, 626, 726, 826, 926, 1026 and/or pin threads 446, 546, 646, 746, 846, 946, 1046. For example, suitable included angles 1150 may be from about 29 degrees to about 90 degrees, and any range or value there between. In an embodiment, the included angle 1150 may be about 60 degrees.

### Optional Thread Treatments

An optional thread treatment may be applied to the box threads 426, 526, 626, 726, 826, 926, 1026 and/or the pin threads 446, 546, 646, 746, 846, 946, 1046 where fatigue may occur. In an embodiment, any suitable optional thread treatment may be applied to the box threads 426, 526, 626, 726, 826, 926, 1026 and/or pin threads 446, 546, 646, 746, 846, 946, 1046. For example, suitable thread treatments include, but are not limited to, cold rolling, shot peening, phosphating, fluoropolymer coating, ceramic coating, chrome plating, anodizing, and combinations or variations thereof. In an embodiment, the optional thread treatment may be cold rolling or shot peening or fluropolymer coating or anodizing.

### Method for Determining a Primary Connection Shoulder Location

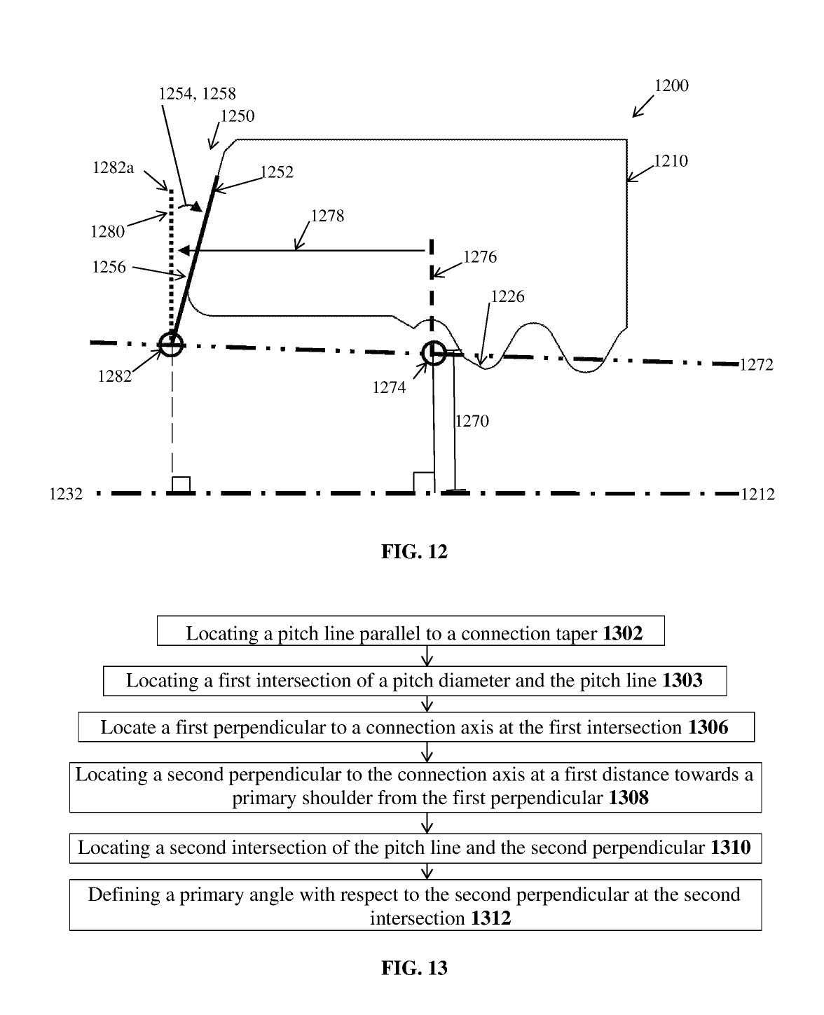

FIG. 12 illustrates a cross-sectional view of an improved primary connection shoulder 1200 according to an embodiment of the present invention.

As shown in FIG. 12, a pitch diameter (i.e., two times the pitch radius 1270) intersects a pitch line 1272 at a first intersection 1274. A first perpendicular 1276 to the connection box/pin axis 1212, 1232 may be offset a first distance 1278 towards a primary box/pin shoulder 1250 to locate a second perpendicular 1280 to the connection box/pin axis 1212, 1232 at the first distance 1278. The pitch line 1272 intersects the second perpendicular 1280 at a second intersection 1282. In an embodiment, the second intersection 1282 may be equal to a datum intersection.

In an embodiment, the first distance 1278 may be from about 0.5 inch to about 2.50 inches, and any range or value there between. In an embodiment, the first distance 1278 may be from about 0.625 inch to about 2.250 inches. In an embodiment, the first distance 1278 may be about 0.625 inch.

In an embodiment, the primary shoulder 1250 comprises a primary box shoulder 1252 at a primary box angle 1254 with respect to a second perpendicular 1280 to the box axis 1212 at a second intersection 1282 of the box connection; and a primary pin shoulder 1256 at a primary pin angle 1258 with respect to the second perpendicular 1280 to the pin axis 1232 at the second intersection 1282 of the pin connection. See also FIG. 1A: 112 & FIG. 1B: 132 (showing box and pin made-up). In an embodiment, the second intersection 1282 may be equal to a datum intersection.

In an embodiment, the primary box shoulder 1252 may be any suitable shape. For example, suitable shapes include, but are not limited to, conical shaped, cylindrical shaped, conical-cylindrical shaped, and variations thereof. In an embodiment, the primary shoulder 1252 may be conical shaped (outside of cone, male).

In an embodiment, the primary pin shoulder 1256 may be any suitable shape. For example, suitable shapes include, but are not limited to, conical shaped, cylindrical shaped, conical-cylindrical shaped, and variations thereof. In an embodiment, the primary pin shoulder 1256 may be conical shaped (inside of cone, female).

In an embodiment, the primary box shoulder 1252 may be any suitable profile. For example, suitable profiles include, but are not limited to, angled profiles. In an embodiment, the primary box shoulder 1252 may be an angled profile defined by a primary box angle 1254, as discussed below.

In an embodiment, the primary box angle 1254 may be from greater than about 0 degrees to less than or equal to about 15 degrees, and any range or value there between. In an embodiment, the primary box angle 1254 may be from greater than about 0 degrees to less than or equal to about 10 degrees. In an embodiment, the primary box angle 1254 may be about 5 degrees.

In an embodiment, the primary pin shoulder 1256 may be any suitable profile. For example, suitable profiles include, but are not limited to, angled profiles. In an embodiment, the primary pin shoulder 1256 may be an angled profile defined by a primary pin angle 1258, as discussed below.

In an embodiment, the primary pin angle 1258 may be from greater than about 0 degrees to less than or equal to about 15 degrees, and any range or value there between. In an embodiment, the primary pin angle 1258 may be from greater than about 0 degrees to less than or equal to about 10 degrees. In an embodiment, the primary pin angle 1258 may be about 5 degrees.

In an embodiment, the primary box angle 1254 may be about equal to the primary pin angle 1258 to form a first seal.

In an embodiment, the primary box angle 1254 may be slightly different from the primary pin angle 1258 to form a first seal. In an embodiment, the first seal may be a gas-tight seal.

FIG. 13 illustrates a flowchart of a method to determine a primary connection shoulder location 1300 according to an embodiment of the present invention. As shown in FIG. 13, the method 1300 comprises locating a pitch line parallel to a connection box/pin taper 1302; locating a first intersection of a pitch diameter and the pitch line 1304; locating a first perpendicular to a connection box/pin axis at the first intersection 1306; locating a second perpendicular to the connection pin/box axis at a first distance towards a primary box/pin shoulder from the first perpendicular (and parallel to the first perpendicular) 1308; and locating a second intersection of the pitch line and the second perpendicular 1310.

In an embodiment, the method 1300 further comprises defining a primary box/pin angle with respect to the second perpendicular at the second intersection 1312.

### Method for Determining a Secondary Connection Shoulder Location

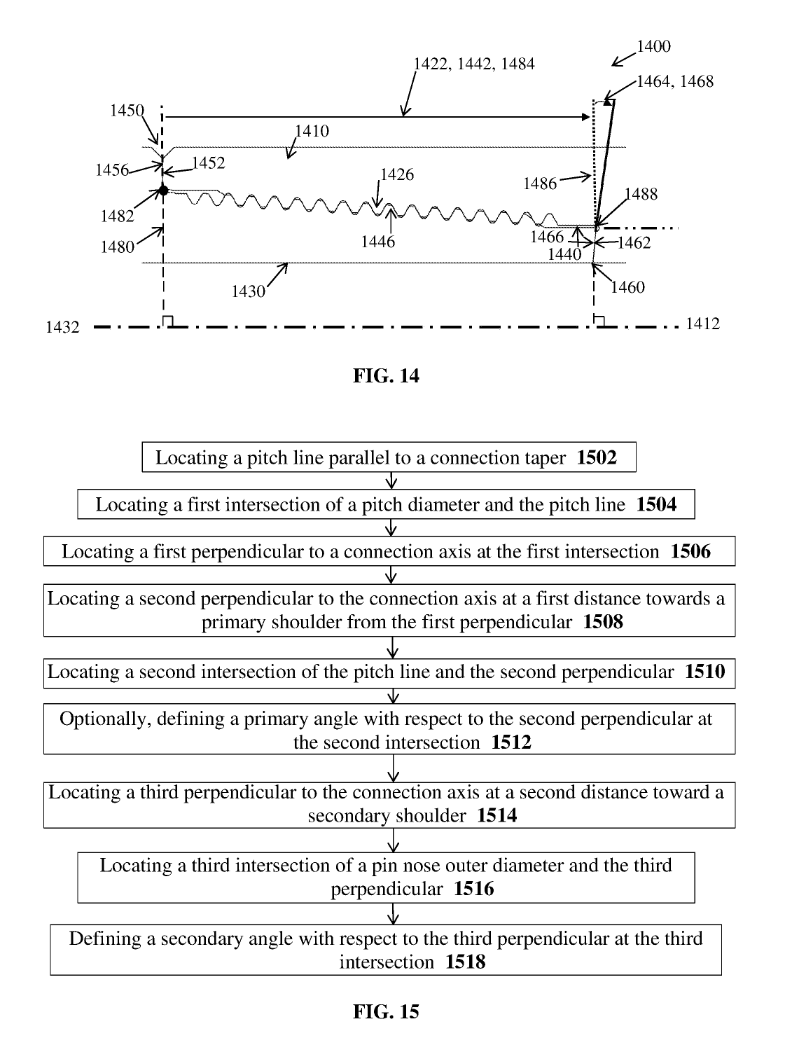

FIG. 14 illustrates a cross-sectional view of an improved secondary connection shoulder 1400 according to an embodiment of the present invention. As discussed above with respect to FIG. 12, the pitch line 1272 intersects the second perpendicular 1280, 1480 at a second intersection 1282. In an embodiment, the second intersection 1282 may be equal to a datum intersection.

A second perpendicular 1480 to the connection box/pin axis 1412, 1432 may be offset a second distance 1484 towards a secondary box/pin shoulder 1460 to locate a third perpendicular 1486 to the connection box/pin axis 1412, 1432 at the second distance 1484.

The pin nose outer diameter (i.e., two times pin nose radius 1440) intersects the third perpendicular 1486 at a third intersection 1488.

In an embodiment, the second distance 1484 may be any suitable distance. In an embodiment, the second distance 1484 may be equal to the connection length. The connection length varies with connection size.

In an embodiment, the second distance 1484 may be about 2 inches to about 8 inches, and any range or value there between.

In an embodiment, the secondary shoulder 1460 comprises a secondary box shoulder 1462 at a secondary box angle 1464 with respect to a third perpendicular 1486 to the box axis 1412 at a third intersection 1488 of the box connection; and a secondary pin shoulder 1466 at a secondary pin angle 1468 with respect to the third perpendicular 1486 to the pin axis 1432 at the third intersection 1488 of the pin connection. See also FIG. 1A: 112 & FIG. 1B: 132 (showing box and pin made-up).

In an embodiment, the secondary box shoulder 1462 may be any suitable shape. For example, suitable shapes include, but are not limited to, conical shaped, cylindrical shaped, conical-cylindrical shaped, and variations thereof. In an embodiment, the secondary shoulder 1462 may be conical shaped (outside of cone, male).

In an embodiment, the secondary pin shoulder 1466 may be any suitable shape. For example, suitable shapes include, but are not limited to, conical shaped, cylindrical shaped, conical-cylindrical shaped, and variations thereof. In an embodiment, the secondary pin shoulder 1466 may be conical shaped (inside of cone, female).

In an embodiment, the secondary box shoulder 1462 may be any suitable profile. For example, suitable profiles include, but are not limited to, angled profiles. In an embodiment, the secondary box shoulder 1462 may be an angled profile defined by a secondary box angle 1464, as discussed below.

In an embodiment, the secondary box angle 1464 may be from greater than or equal to about 0 degrees to less than or equal to about 15 degrees, and any range or value there between. In an embodiment, the secondary box angle 1464 may be from greater than or equal to about 0 degrees to less than or equal to about 10 degrees. In an embodiment, the secondary box angle 1464 may be about 5 degrees.

In an embodiment, the secondary pin shoulder 1466 may be any suitable profile. For example, suitable profiles include, but are not limited to, angled profiles. In an embodiment, the secondary pin shoulder 1466 may be an angled profile defined by a secondary pin angle 1468, as discussed below.

In an embodiment, the secondary pin angle 1468 may be from greater than or equal to about 0 degrees to less than or equal to about 15 degrees, and any range or value there between. In an embodiment, the secondary pin angle 1468 may be from greater than or equal to about 0 degrees to less than or equal to about 10 degrees. In an embodiment, the secondary pin angle 1468 may be about 5 degrees.

In an embodiment, the secondary box angle 1464 may be about equal to the secondary pin angle 1468 to form a torque shoulder.

In an embodiment, the secondary box angle 1464 may be slightly different from the secondary pin angle 1468 to form a torque shoulder that is a second seal. In an embodiment, the torque shoulder or second seal may be a gas-tight seal.

FIG. 15 illustrates a flowchart of a method to determine a secondary connection shoulder location 1500 according to an embodiment of the present invention. As shown in FIG. 15, the method 1500 comprises locating a pitch line parallel to a connection box/pin taper 1502; locating a first intersection of a pitch diameter and the pitch line 1504; locating a first perpendicular to the connection box/pin axis at the first intersection 1506; locating a second perpendicular to the connection pin/box axis at a first distance towards a primary box/pin shoulder from the first perpendicular (and parallel to the first perpendicular) 1508; locating a second intersection of the pitch line and the second perpendicular 1510; optionally, defining a primary box/pin angle with respect to the second perpendicular at the second intersection 1512; locating a third perpendicular to the connection box/pin axis at a second distance (connection length) toward a secondary box/pin shoulder (and parallel to the second perpendicular) 1514; and locating a third intersection of a pin nose outer diameter and the third perpendicular 1516.

In an embodiment, the method 1500 further comprises defining a secondary box/pin angle with respect to the third perpendicular at the third intersection 1518.

Method of Using Improved Double-Shoulder Connection with Angled Primary Shoulder or Improved Single-Shoulder Connection with Angled Primary Shoulder

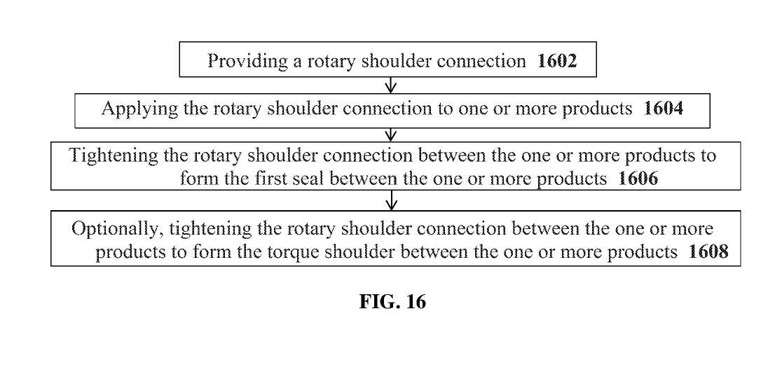

FIG. 16 illustrates a flowchart of a method of using an improved double-shoulder connection with an angled primary shoulder or an improved single-shoulder connection with an angled primary shoulder 1600 according to an embodiment of the present invention. As shown in FIG. 16, the method 1600 comprises providing a rotary shoulder connection 1602, and applying the rotary shoulder connection to one or more products 1604.

In an embodiment, the rotary shoulder connection may be the improved double-shoulder connection 400, 500, 700 with an angled primary shoulder 450, 550, 750 or the improved double-shoulder connection 600 with an angled secondary shoulder 660, or the improved single-shoulder connection 800, 900, 1000 with an angled primary shoulder 850, 950, 1050, as discussed above.

In an embodiment, the rotary shoulder connection may be the improved double-shoulder connection 400, 500, 600, 700 with an angled primary shoulder 450, 550, 750 and/or an angled secondary shoulder 660, 760, as discussed above.

In an embodiment, the method 1600 further comprises tightening the rotary shoulder connection between the one or more products to form a first seal at an angled primary shoulder 450, 550, 650, 750, 850, 950, 1050.

In an embodiment, the method 1600 further comprises tightening the rotary shoulder connection between the one or more products to form a first seal at an angled primary shoulder 450, 550, 750 and/or a torque shoulder at an angled secondary shoulder 660, 760.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms (e.g., “outer” and “inner,” “upper” and “lower,” “first” and “second,” “internal” and “external,” “above” and “below” and the like) are used as words of convenience to provide reference points and, as such, are not to be construed as limiting terms.

The embodiments set forth herein are presented to best explain the present invention and its practical application and to thereby enable those skilled in the art to make and utilize the invention. However, those skilled in the art will recognize that the foregoing description has been presented for the purpose of illustration and example only. The description as set forth is not intended to be exhaustive or to limit the invention to the precise form disclosed. Many modifications and variations are possible in light of the above teaching without departing from the spirit and scope of the following claims.

Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

Definitions

As used herein, the terms “a,” “an,” “the,” and “said” mean one or more, unless the context dictates otherwise.

As used herein, the term “about” means the stated value plus or minus a margin of error plus or minus 10% if no method of measurement is indicated.

As used herein, the term “or” means “and/or” unless explicitly indicated to refer to alternatives only or if the alternatives are mutually exclusive.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “containing,” “contains,” and “contain” have the same open-ended meaning as “comprising,” “comprises,” and “comprise,” provided above.

As used herein, the terms “having,” “has,” and “have” have the same open-ended meaning as “comprising,” “comprises,” and “comprise,” provided above.

As used herein, the terms “including,” “includes,” and “include” have the same open-ended meaning as “comprising,” “comprises,” and “comprise,” provided above.

As used herein, the phrase “consisting of” is a closed transition term used to transition from a subject recited before the term to one or more material elements recited after the term, where the material element or elements listed after the transition term are the only material elements that make up the subject.

As used herein, the phrase “material yields” means the material has exceeded its modulus of elasticity.

As used herein, the term “simultaneously” means occurring at the same time or about the same time, including concurrently.

Incorporation By Reference. All patents and patent applications, articles, reports, and other documents cited herein are fully incorporated by reference to the extent they are not inconsistent with this invention.

What is claimed is:

1. A rotary shoulder connection comprising:
(a) A box connection having a box axis, wherein the box connection has a box outer radius, a box counter bore radius and a box inner radius, and box threads having a box thread form cut along a box taper;
(b) A pin connection having a pin axis, wherein the pin connection has a pin outer radius, a pin cylinder radius and a pin nose radius, and pin threads having a pin thread form cut along a pin taper to align with the box threads inside the box connection; and
(c) A primary shoulder connection at a first end of the box connection and a first end of the pin connection comprising:
i. A primary box shoulder at a primary box angle with respect to a first perpendicular to the box axis at a first end point, wherein the primary box angle is from greater than about 0 degrees to less than or equal to about 15 degrees;
ii. A primary pin shoulder at a primary pin angle with respect to the first perpendicular to the pin axis at the first end point, wherein the primary pin angle is from greater than about 0 degrees to less than or equal to about 15 degrees; and
iii. wherein the primary box shoulder contacts the primary pin shoulder to form a first seal.

2. The rotary shoulder connection of claim 1, wherein the first end point is equal to a datum intersection.

3. The rotary shoulder connection of claim 1, wherein the primary box angle is from greater than about 0 degrees to less than or equal to about 10 degrees and the primary pin angle is from greater than about 0 degrees to less than or equal to about 10 degrees.

4. The rotary shoulder connection of claim 1, wherein the primary box angle is about 5 degrees and the primary pin angle is about 5 degrees.

5. The rotary shoulder connection of claim 1, wherein the primary box angle is about equal to the primary pin angle to form the first seal.

6. The rotary shoulder connection of claim 1, wherein the primary box angle is slightly different than the primary pin angle to form the first seal.

7. The rotary shoulder connection of claim 1, wherein the primary box shoulder is conical shaped (outside of cone, male) and the primary pin shoulder is conical shaped (inside of cone, female).

8. The rotary shoulder connection of claim 1, wherein the box thread form comprises a first box thread crest, a second box thread crest, a first box thread flank, a second box thread flank, a box included angle between the first box thread flank and the second box thread flank, and a box thread root, and wherein the pin thread form comprises a first pin thread crest, a second pin thread crest, a first pin thread flank, a second pin thread flank, a pin included angle between the first pin thread flank and the second pin thread flank, and a pin thread root.

9. The rotary shoulder connection of claim 8, wherein the box thread form is selected from the group consisting of square, triangular, trapezoidal, and variations thereof, and wherein the pin thread form is selected from the group consisting of square, triangular, trapezoidal, and variations thereof.

10. The rotary shoulder connection of claim 8, wherein the first box thread crest and/or the second box thread crest is circular, square, triangular or trapezoidal shaped, and wherein the first pin thread crest and/or the second pin thread crest is circular, square, triangular or trapezoidal shaped.

11. The rotary shoulder connection of claim 8, wherein the first box thread flank and/or the second box thread flank are concave, convex, or straight shaped, and wherein the first pin thread flank and/or the second pin thread flank are concave, convex, or straight shaped.

12. The rotary shoulder connection of claim 8, wherein the box thread root is circular, square, triangular or trapezoidal shaped, and wherein the pin thread root is circular, square, triangular or trapezoidal shaped.

13. The rotary shoulder connection of claim 8, wherein the box included angle is from about 29 degrees to about 90 degrees, and wherein the pin included angle is from about 29 degrees to about 90 degrees.

14. The rotary shoulder connection of claim 8, wherein the box thread form is triangular and the box included angle is about 60 degrees, and wherein the pin thread form is triangular shaped and the pin included angle is about 60 degrees.

15. The rotary shoulder connection of claim 1, wherein the box threads and/or the pin threads are treated by one or more of cold rolling, shot peening, phosphating, fluoropolymer coating, ceramic coating, chrome plating, anodizing, and variations thereof.

16. The rotary shoulder connection of claim 1, wherein the box threads and/or the pin threads are treated by one or more of cold rolling, shot peening, fluoropolymer coating, and anodizing.

17. The rotary shoulder connection of claim 1 further comprising one or more of a box boreback, a box stress relief groove and a pin stress relief groove.

18. The rotary shoulder connection of claim 1, wherein the rotary shoulder connection is made from one or more of low alloy steels, stainless steels, super alloys, titanium alloys, copper alloys, cobalt alloys, aluminum alloys, and variations thereof.

19. The rotary shoulder connection of claim 1, wherein the rotary shoulder connection is made from one or more of low alloy steels, stainless steels, and variations thereof.

20. The rotary shoulder connection of claim 1, wherein the rotary shoulder connection is applied to one or more of drill pipe, heavy weight drill pipe, drill collars, pup joints, crossover subs, saver subs, bit subs, float subs, pump-in subs, inside blowout preventers, top drive shafts, top drive valves, safety valves, kelly valves, hoisting equipment, swivels, fishing tools, mud motors, rotary steerable tools, drill bits, directional drilling bottom hole assembly components, measurement while drilling components, logging while drilling components, well cleanout tools, completion tools, and variations thereof.

21. The rotary shoulder connection of claim 1, wherein the rotary shoulder connection is applied to one or more of drill pipe, heavy weight drill pipe, drill collars, pup joints, and variations thereof.

22. The rotary shoulder connection of claim 1, further comprising:
(a) a secondary shoulder connection at a second end of the box connection and a second end of the pin connection comprising:
i. A secondary box shoulder at a secondary box angle with respect to a second perpendicular to the box axis at a second end point, wherein the secondary box angle is from greater than or equal to about 0 degrees to less than or equal to about 15 degrees;
ii. A secondary pin shoulder at a secondary pin angle with respect to the second perpendicular to the pin axis at the second end point, wherein the secondary pin angle is from greater than or equal to about 0 degrees to less than or equal to about 15 degrees; and
iii. wherein the secondary box shoulder contacts the secondary pin shoulder to form a torque shoulder.

23. The rotary shoulder connection of claim 22, wherein the second end is offset a first distance from the first end.

24. The rotary shoulder connection of claim 23, wherein the first distance is a connection length.

25. The rotary shoulder connection of claim 22, wherein the secondary box angle is from greater than or equal to about 0 degrees to less than or equal to 10 degrees and the secondary pin angle is from greater than or equal to about 0 degrees to less than or equal to about 10 degrees.

26. The rotary shoulder connection of claim 22, wherein the secondary box angle is about 5 degrees and the secondary pin angle is about 5 degrees.

27. The rotary shoulder connection of claim 22, wherein the secondary box angle is about 0 degrees and the secondary pin angle is about 0 degrees.

28. The rotary shoulder connection of claim 22, wherein the secondary box angle is about equal to the secondary pin angle to form the torque shoulder.

29. The rotary shoulder connection of claim 22, wherein the secondary box angle is slightly different than the secondary pin angle to form the torque shoulder.

30. The rotary shoulder connection of claim 22, wherein the secondary box shoulder is conical shaped (outside of cone, male) and the secondary pin shoulder is conical shaped (inside of cone, female).

31. The rotary shoulder connection of claim 22, wherein the box thread form comprises a first box thread crest, a second box thread crest, a first box thread flank, a second box thread flank, a box included angle between the first box thread flank and the second box thread flank, and a box thread root, and wherein the pin thread form comprises a first pin thread crest, a second pin thread crest, a first pin thread flank, a second pin thread flank, a pin included angle between the first pin thread flank and the second pin thread flank, and a pin thread root.

32. The rotary shoulder connection of claim 31, wherein the box thread form is selected from the group consisting of square, triangular, trapezoidal, and variations thereof, and wherein the pin thread form is selected from the group consisting of square, triangular, trapezoidal, and variations thereof.

33. The rotary shoulder connection of claim 31, wherein the box thread crest is circular, square, triangular or trapezoidal shaped, and wherein the pin thread crest is circular, square, triangular or trapezoidal shaped.

34. The rotary shoulder connection of claim 31, wherein the first box thread flank and/or the second box thread flank are concave, convex, or straight shaped, and wherein the first pin thread flank and/or the second pin thread flank are concave, convex, or straight shaped.

35. The rotary shoulder connection of claim 31, wherein the box thread root is circular, square, triangular or trapezoidal shaped, and wherein the pin thread root is circular, square, triangular or trapezoidal shaped.

36. The rotary shoulder connection of claim 31, wherein the box included angle is from about 29 degrees to about 90 degrees, and wherein the pin included angle is from about 29 degrees to about 90 degrees.

37. The rotary shoulder connection of claim 31, wherein the box thread form is triangular and the box included angle is about 60 degrees, and wherein the pin thread form is triangular shaped and the pin included angle is about 60 degrees.

38. The rotary shoulder connection of claim 22, wherein the box threads and/or the pin threads are treated by one or more of cold rolling, shot peening, phosphating, fluoropolymer coating, ceramic coating, chrome plating, anodizing, and variations thereof.

39. The rotary shoulder connection of claim 22, wherein the box threads and/or the pin threads are treated by one or more of cold rolling, shot peening, fluoropolymer coating, and anodizing.

40. The rotary shoulder connection of claim 22 further comprising one or more of a box boreback, a box stress relief groove and a pin stress relief groove.

41. The rotary shoulder connection of claim 22, wherein the rotary shoulder connection is made from one or more of low alloy steels, stainless steels, super alloys, titanium alloys, copper alloys, cobalt alloys, aluminum alloys, and variations thereof.

42. The rotary shoulder connection of claim 22, wherein the rotary shoulder connection is made from one or more of low alloy steels, stainless steels, and variations thereof.

43. The rotary shoulder connection of claim 22, wherein the rotary shoulder connection is applied to one or more of drill pipe, heavy weight drill pipe, drill collars, pup joints, crossover subs, saver subs, bit subs, float subs, pump-in subs, inside blowout preventers, top drive shafts, top drive valves, safety valves, kelly valves, hoisting equipment, swivels, fishing tools, mud motors, rotary steerable tools, drill bits, directional drilling bottom hole assembly components, measurement while drilling components, logging while drilling components, well cleanout tools, completion tools, and variations thereof.

44. The rotary shoulder connection of claim 22, wherein the rotary shoulder connection is applied to one or more of drill pipe, heavy weight drill pipe, drill collars, pup joints, and variations thereof.

45. A rotary shoulder connection comprising:
(a) A box connection having a box axis, wherein the box connection has a box outer radius, a box counter bore radius and a box inner radius, and box threads having a box thread form cut along a box taper;
(b) A pin connection having a pin axis, wherein the pin connection has a pin outer radius, a pin cylinder radius and a pin nose radius, and pin threads having a pin thread form cut along a pin taper to align with the box threads inside the box connection; and
(c) a secondary shoulder connection at a second end of the box connection and a second end of the pin connection comprising:
i. A secondary box shoulder at a secondary box angle with respect to a first perpendicular to the box axis at a first end point, wherein the secondary box angle is from greater than about 0 degrees to less than or equal to about 15 degrees;
ii. A secondary pin shoulder at a secondary pin angle with respect to the first perpendicular to the pin axis at the first end point, wherein the secondary pin angle is from greater than about 0 degrees to less than or equal to about 15 degrees; and
iii. wherein the secondary box shoulder contacts the secondary pin shoulder to form a torque shoulder.

46. The rotary shoulder connection of claim 45, wherein the first end is offset a first distance from a second end.

47. The rotary shoulder connection of claim 46, wherein the first distance is a connection length.

48. The rotary shoulder connection of claim 45, wherein the secondary box angle is from greater than about 0 degrees to less than or equal to about 10 degrees and the secondary pin angle is from greater than about 0 degrees to less than or equal to about 10 degrees.

49. The rotary shoulder connection of claim 45, wherein the secondary box angle is about 5 degrees and the secondary pin angle is about 5 degrees.

50. The rotary shoulder connection of claim 45, wherein the secondary box angle is about equal to the secondary pin angle to form the torque shoulder.

51. The rotary shoulder connection of claim 45, wherein the secondary box angle is slightly different than the secondary pin angle to form the torque shoulder.

52. The rotary shoulder connection of claim 45, wherein the secondary box shoulder is conical shaped (outside of cone, male) and the secondary pin shoulder is conical shaped (inside of cone, female).

53. The rotary shoulder connection of claim 45, wherein the box thread form comprises a first box thread crest, a second box thread crest, a first box thread flank, a second box thread flank, a box included angle between the first box thread flank and the second box thread flank, and a box thread root, and wherein the pin thread form comprises a first pin thread crest, a second pin thread crest, a first pin thread flank, a second pin thread flank, a pin included angle between the first pin thread flank and the second pin thread flank, and a pin thread root.

54. The rotary shoulder connection of claim 53, wherein the box thread form is selected from the group consisting of square, triangular, trapezoidal, and variations thereof, and wherein the pin thread form is selected from the group consisting of square, triangular, trapezoidal, and variations thereof.

55. The rotary shoulder connection of claim 53, wherein the box thread crest is circular, square, triangular or trapezoidal shaped, and wherein the pin thread crest is circular, square, triangular or trapezoidal shaped.

56. The rotary shoulder connection of claim 53, wherein the first box thread flank and/or the second box thread flank are concave, convex, or straight shaped, and wherein the first pin thread flank and/or the second pin thread flank are concave, convex, or straight shaped.

57. The rotary shoulder connection of claim 53, wherein the box thread root is circular, square, triangular or trapezoidal shaped, and wherein the pin thread root is circular, square, triangular or trapezoidal shaped.

58. The rotary shoulder connection of claim 53, wherein the box included angle is from about 29 degrees to about 90 degrees, and wherein the pin included angle is from about 29 degrees to about 90 degrees.

59. The rotary shoulder connection of claim 53, wherein the box thread form is triangular and the box included angle is about 60 degrees, and wherein the pin thread form is triangular shaped and the pin included angle is about 60 degrees.

60. The rotary shoulder connection of claim 45, wherein the box threads and/or the pin threads are treated by one or more of cold rolling, shot peening, phosphating, fluoropolymer coating, ceramic coating, chrome plating, anodizing, and variations thereof.

61. The rotary shoulder connection of claim 45, wherein the box threads and/or the pin threads are treated by one or more of cold rolling, shot peening, fluoropolymer coating, and anodizing.

62. The rotary shoulder connection of claim 45 further comprising one or more of a box boreback, a box stress relief groove and a pin stress relief groove.

63. The rotary shoulder connection of claim 45, wherein the rotary shoulder connection is made from one or more of low alloy steels, stainless steels, super alloys, titanium alloys, copper alloys, cobalt alloys, aluminum alloys, and variations thereof.

64. The rotary shoulder connection of claim 45, wherein the rotary shoulder connection is made from one or more of low alloy steels, stainless steels, and variations thereof.

65. The rotary shoulder connection of claim 45, wherein the rotary shoulder connection is applied to one or more of drill pipe, heavy weight drill pipe, drill collars, pup joints, crossover subs, saver subs, bit subs, float subs, pump-in subs, inside blowout preventers, top drive shafts, top drive valves, safety valves, kelly valves, hoisting equipment, swivels, fishing tools, mud motors, rotary steerable tools, drill bits, directional drilling bottom hole assembly components, measurement while drilling components, logging while drilling components, well cleanout tools, completion tools, and variations thereof.

66. The rotary shoulder connection of claim 45, wherein the rotary shoulder connection is applied to one or more of drill pipe, heavy weight drill pipe, drill collars, pup joints, and variations thereof.

67. The rotary shoulder connection of claim 45 further comprising:
(a) A primary shoulder connection at a second end of the box connection and a second end of the pin connection comprising:
i. A primary box shoulder at a primary box angle with respect to a second perpendicular to the box axis at a second end point, wherein the primary box angle is about 0 degrees;
ii. A primary pin shoulder at a primary pin angle with respect to the second perpendicular to the pin axis at the second end point, wherein the primary pin angle is about 0 degrees; and
iii. wherein the primary box shoulder contacts the primary pin shoulder to form a first seal.

68. The rotary shoulder connection of claim 67, wherein the second end point is equal to a datum intersection.

69. The rotary shoulder connection of claim 67, wherein the primary box angle is about equal to the primary pin angle to form the first seal.

70. The rotary shoulder connection of claim 67, wherein the primary box angle is slightly different than the primary pin angle to form the first seal.

71. The rotary shoulder connection of claim 67, wherein the box thread form comprises a first box thread crest, a second box thread crest, a first box thread flank, a second box thread flank, a box included angle between the first box thread flank and the second box thread flank, and a box thread root, and wherein the pin thread form comprises a first pin thread crest, a second pin thread crest, a first pin thread flank, a second pin thread flank, a pin included angle between the first pin thread flank and the second pin thread flank, and a pin thread root.

72. The rotary shoulder connection of claim 71, wherein the box thread form is selected from the group consisting of square, triangular, trapezoidal, and variations thereof, and wherein the pin thread form is selected from the group consisting of square, triangular, trapezoidal, and variations thereof.

73. The rotary shoulder connection of claim 71, wherein the first box thread crest and/or the second box thread crest is circular, square, triangular or trapezoidal shaped, and wherein the first pin thread crest and/or the second pin thread crest is circular, square, triangular or trapezoidal shaped.

74. The rotary shoulder connection of claim 71, wherein the first box thread flank and/or the second box thread flank are concave, convex, or straight shaped, and wherein the first pin thread flank and/or the second pin thread flank are concave, convex, or straight shaped.

75. The rotary shoulder connection of claim 71, wherein the box thread root is circular, square, triangular or trapezoidal shaped, and wherein the pin thread root is circular, square, triangular or trapezoidal shaped.

76. The rotary shoulder connection of claim 71, wherein the box included angle is from about 29 degrees to about 90 degrees, and wherein the pin included angle is from about 29 degrees to about 90 degrees.

77. The rotary shoulder connection of claim 71, wherein the box thread form is triangular and the box included angle is about 60 degrees, and wherein the pin thread form is triangular shaped and the pin included angle is about 60 degrees.

78. The rotary shoulder connection of claim 67, wherein the box threads and/or the pin threads are treated by one or more of cold rolling, shot peening, phosphating, fluoropolymer coating, ceramic coating, chrome plating, anodizing, and variations thereof.

79. The rotary shoulder connection of claim 67, wherein the box threads and/or the pin threads are treated by one or more of cold rolling, shot peening, fluoropolymer coating, and anodizing.

80. The rotary shoulder connection of claim 67 further comprising one or more of a box boreback, a box stress relief groove and a pin stress relief groove.

81. The rotary shoulder connection of claim 67, wherein the rotary shoulder connection is made from one or more of low alloy steels, stainless steels, super alloys, titanium alloys, copper alloys, cobalt alloys, aluminum alloys, and variations thereof.

82. The rotary shoulder connection of claim 67, wherein the rotary shoulder connection is made from one or more of low alloy steels, stainless steels, and variations thereof.

83. The rotary shoulder connection of claim 67, wherein the rotary shoulder connection is applied to one or more of drill pipe, heavy weight drill pipe, drill collars, pup joints, crossover subs, saver subs, bit subs, float subs, pump-in subs, inside blowout preventers, top drive shafts, top drive valves, safety valves, kelly valves, hoisting equipment, swivels, fishing tools, mud motors, rotary steerable tools, drill bits, directional drilling bottom hole assembly components, measurement while drilling components, logging while drilling components, well cleanout tools, completion tools, and variations thereof.

84. The rotary shoulder connection of claim 67, wherein the rotary shoulder connection is applied to one or more of drill pipe, heavy weight drill pipe, drill collars, pup joints, and variations thereof.

85. A method of using a rotary shoulder connection comprising:
(a) providing the rotary shoulder connection of claim 1; and
(b) applying the rotary shoulder connection to one or more products.

86. The method of claim 85, further comprising tightening the rotary shoulder connection between one of more products to form the first seal.

87. A method of using a rotary shoulder connection comprising:
(a) providing the rotary shoulder connection of claim 22; and
(b) applying the rotary shoulder connection to one or more products.

88. The method of claim 87 further comprising tightening the rotary shoulder connection between the one or more products to form the first seal.

89. The method of claim 87 further comprising tightening the rotary shoulder connection between the one or more products to form the first seal and the torque shoulder.

90. A method of using a rotary shoulder connection comprising:
(a) providing the rotary shoulder connection of claim 45; and
(b) applying the rotary shoulder connection to one or more products.

91. The method of claim 90, further comprising tightening the rotary shoulder connection between one of more products to form the torque shoulder.

92. A method of using a rotary shoulder connection comprising:
(a) providing the rotary shoulder connection of claim 67; and
(b) applying the rotary shoulder connection to one or more products.

93. The method of claim 92 further comprising tightening the rotary shoulder connection between the one or more products to form the torque shoulder.

94. The method of claim 92 further comprising tightening the rotary shoulder connection between the one or more products to form the first seal and the torque shoulder.

95. A method for determining a primary shoulder location comprising:
(a) locating a pitch line parallel to a connection box/pin taper;
(b) locating a first intersection of a pitch diameter and the pitch line;
(c) locating a first perpendicular to the connection box/pin axis at the first intersection;
(d) locating a second perpendicular to the connection box/pin axis at a first distance towards a primary box/pin shoulder from the first perpendicular; and
(e) locating a second intersection of the pitch line and the second perpendicular.

96. The method of claim 95 further comprising step (f) defining a primary box/pin angle with respect to the second perpendicular at the second intersection.

97. The method of claim 95, wherein the first distance is from about 0.5 inch to about 2.50 inches.

98. The method of claim 95, wherein the first distance is from about 0.625 inch to about 2.250 inch.

99. The method of claim 95, wherein the first distance is about 0.625 inch.

100. A method for determining a secondary shoulder connection location comprising:
(a) locating a pitch line parallel to a connection box/pin taper;
(b) locating a first intersection of a pitch diameter and the pitch line;
(c) locating a first perpendicular to the connection box/pin axis at the first intersection;
(d) locating a second perpendicular to the connection box/pin axis at a first distance towards a primary box/pin shoulder from the first perpendicular;
(e) locating a second intersection of the pitch line and the second perpendicular;
(f) locating a third perpendicular to the connection box/pin axis at a second distance toward a secondary box/pin shoulder; and
(g) locating a third intersection of a pin nose outer diameter and the third perpendicular.

101. The method of claim 100 further comprising step (h) optionally, defining a primary box/pin angle with respect to the second perpendicular at the second intersection and defining a secondary box/pin angle with respect to the third perpendicular at the third intersection.

102. The method of claim 100 further comprising step (h) defining a secondary box/pin angle with respect to the third perpendicular at the third intersection.

103. The method of claim 100, wherein the second distance is a connection length.

104. The method of claim 100, wherein the second distance is from about 2 inches to about 8 inches.
